(19) United States
(12) Patent Application Publication
(10) Pub. No.: US 2025/0215253 A1
(43) Pub. Date: Jul. 3, 2025

(54) TOPICAL ASPHALT REJUVENATOR AND SEALER COMPOSITION

(71) Applicant: AZTEC ASPHALT TECHNOLOGIES LLC, York, PA (US)

(72) Inventors: Michael Ray Leaman, York, PA (US); Derek Crawford, Mars, PA (US)

(21) Appl. No.: 18/844,240

(22) PCT Filed: Mar. 7, 2023
(86) PCT No.: PCT/US2023/063854

§ 371 Date: Sep. 5, 2024

Related U.S. Application Data
(60) Provisional application No. 63/317,182, filed on Mar. 7, 2022.

(51) Int. Cl. C09D 133/12; C09D 5/02; C09D 7/45; C09D 7/61; C09D 7/63; C09D 7/65; E01C 7/18

(52) U.S. Cl. CPC C09D 133/12; C09D 5/022; C09D 5/027; C09D 5/028; C09D 7/45; C09D 7/61; C09D 7/63; C09D 7/65; E01C 7/187

(57) ABSTRACT

The present application relates to rejuvenation of asphalt structures and more particularly to rejuvenating asphalt pavement by application of a rejuvenating composition so that the reclaimed asphalt properties more closely resemble those of virgin asphalt.

### FIELD OF THE INVENTION

Embodiments herein are directed to rejuvenation of asphalt structures and more particularly to rejuvenating asphalt pavement by application of a rejuvenating composition so that the reclaimed asphalt properties more closely resemble those of virgin asphalt.

### BACKGROUND

Asphalt pavement is an aggregate of three elements: sand, stone and, asphalt cement, a binder that holds the mixture together. The majority of pavements are composed of asphalt concrete and/or Portland cement concrete. The asphalt binder is composed of asphaltenes and maltenes, two petroleum factions that react with oxygen. Oxidation changes the molecular make-up of the binder causing it to harden and lose its ability to hold the aggregate in place. Oxidative aging causes a significant chemical degradation in the asphalt that weakens pavement, making it susceptible to surface and structural damage.

Since pavements oxidize and age over their performance lifetime, there is a continuing requirement to address the wear issues that result with the passage of time. Surface pavement rejuvenation products have been used for the last 50 years to help preserve the pavement and delay the need for costly complete resurfacing.

Modern asphalt and concrete surfaces are designed for high durability and are under increasing service life demands. Weather, road salt, and traffic, among others, contribute to deterioration of asphalt and concrete surfaces. Asphalt pavement begins to age from the time it is first produced. As it ages it loses flexibility, becomes brittle and loses skid resistance. Over time this deterioration can ultimately result in damage such as cracks, holes, voids. Non-road asphalt surfaces such as driveways, parking lots, and the like can have cracks, holes, and other discontinuities that are unaesthetic. Brittleness of asphalt pavement is measured by the viscosity, or thickness, of the binder. Viscosity is a measure of the resistance of a fluid by shear stress or tensile stress. The less viscous the fluid is, the greater its ease of movement. In other words, as the binder loses viscosity and grows thicker over time, asphalt pavement becomes more brittle and significant aging damage occurs.

Without regular maintenance, asphalt can deteriorate rapidly and will then need to be milled and replaced. Pavement preservation is a maintenance technique that extends the service life of asphalt through rejuvenation as opposed to repaving. Asphalt rejuvenation works on a molecular level by penetrating the surface of the asphalt and stopping the oxidation process. This interruption to the oxidation process changes the molecular composition of the asphalt binder resulting in a significant drop in viscosity, which results in increased binder flexibility (enhanced viscoelastic binder properties). Thus, the service life of asphalt pavement is dramatically increased.

Reclaimed Asphalt Pavement (RAP) is the term given to removed and/or reprocessed pavement materials containing asphalt and aggregates. These materials are generated when asphalt pavements are removed for reconstruction or resurfacing due to aging or other reason such as to obtain access to buried utilities. When properly crushed and screened, RAP consists of high-quality, well-graded aggregates coated by asphalt cement.

The majority of the RAP that is produced is recycled and used, although not always in the same year that it is produced. Recycled RAP is almost always returned back into the roadway structure in some form, usually incorporated into asphalt paving by means of hot or cold recycling. Before being introduced back into a “new” asphalt mix, RAP must undergo a process of rejuvenation in order to become homogeneous with the new asphalt. The rheology of the aged RAP must be bought back to a suitable level in order to form a homogeneous “new” batch of asphalt for paving. In many instances, the RAP is mixed with a rejuvenator compound and the admixture applied to the milled road surface.

Road preservation in situ, and the addition of RAP to asphalt mixes both require a rejuvenator to be introduced.

In both applications, rejuvenating agents are products designed to restore original properties to aged (oxidized) asphalt binders by restoring the original ratio of asphaltenes to maltenes. Maltenes are the n-alkane (pentane or heptane)-soluble molecular components of asphalt, which is the residue remaining after petroleum refiners remove other useful derivatives such as gasoline and kerosene from crude oil. Asphaltene compounds are the other primary component of asphalt. As asphalt ages the balance between these two components in the binder needed to maintain the viscoelastic properties of the binder (and the pavement) is disturbed resulting in a brittle binder, leading to raveling (deterioration of the pavement by loss of asphalt and rocks), cracking and ultimately replacement.

Rejuvenating agents restore a portion of the asphalt paving properties and binder bitumen physical properties, such as viscoelastic behavior, so that the reclaimed asphalt properties more closely resemble those of virgin asphalt. Improving the properties of recycled asphalt, and particularly the properties of bitumen binder in RAP, allows increased amounts of RAP to be used in asphalt mixtures without compromising the properties and lifetime of the final pavement.

Commonly used rejuvenating agents for RAP include low-viscosity products obtained by crude oil distillation or other hydrocarbon oil-based materials (see, e.g., U.S. Pat. No. 5,766,333 or U.S. Pat. No. 6,117,227).

Rejuvenating agents of plant origin have also been described. See, for example, U.S. Pat. No. 7,811,372 (rejuvenating agents comprising bitumen and palm oil); U.S. Pat. No. 7,008,670 (soybean oil, alkyl esters from soybean oil, and terpenes used for sealing or rejuvenating); U.S. Pat. Appl. Pub. No. 2010/0034586 (rejuvenating agent based on soybean, sunflower, rapeseed, or other plant-derived oils); and

U.S. Pat. Appl. Pub. No. 2008/0041276 discloses plasticizers for recycled asphalt that may be vegetable oils or alkyl esters made from vegetable oil). U.S. Pat. No. 8,076,399 describes a binder composition comprising a resin of vegetable origin, a vegetable oil, and a polymer having anhydride, carboxylic so that the reclaimed asphalt properties more closely resemble those of virgin asphalt acid, or epoxide functionality, but this binder is not specifically taught for rejuvenation. Although vegetable oils can provide desirable softening of aged binders, they can leach from the rejuvenated asphalt.

Also available are rejuvenating agents derived from cashew nut shell oil, which contain mostly cardanol, a phenolic compound having a C15 unsaturated chain (see, e.g., PCT Int. Pub. Nos. WO 2010/077141 and WO 2010/110651).

Asphalt rejuvenation is the process of restoring chemical properties that have been deteriorating since the moment new asphalt was laid down, either topically or in RAP. Historically, asphalt rejuvenators are made from coal tar blended with aromatic oils and solvents. Given the importance of environmental considerations, it is desirable to avoid use of restoration agents containing volatile organic compounds. There is a need for improved methods to repair pavements, by arresting or delaying the deterioration of visco-elastic properties of the pavements, while simultaneously rejuvenating, or restoring some of the pavements' original properties. Also, desirable is a quick drying rejuvenating agent that can be applied by spraying onto the pavement surface. Short drying time is an important property of a road rejuvenation composition as abbreviated drying time reduces the time the pavement being treated is closed to vehicular traffic. It would also be desirable to have a green (bio based) non-aromatic pavement rejuvenation composition or that could be applied to a pavement surface and dry quickly to enable passage of vehicles on the treated road surface.

Improved rejuvenating agents for reclaiming asphalt are needed. Ideally, an improved rejuvenating agent would derive from renewable resources, would be non-toxic, quick drying, bio-based, avoid the presence of volatile organic compounds (VOCs), be capable of direct application to pavement such as by spraying, and would be capable of restoring pavement rheological properties close to those present in the original pavement.

### SUMMARY

Disclosed herein is a sprayable, non-toxic, quick drying, water based composition that can be applied directly to existing asphalt pavement surfaces to provide a high level of rejuvenation to such asphalt. The material penetrates the asphalt surface, largely restores the rheological properties of the asphalt pavement, contains no volatile organic compounds (VOCs), dries quickly after application, is non-HAZMAT for easy handling and poses no run off danger after contact with ground water or foliage.

The rejuvenating compositions disclosed herein clean up with soap and water, and dry in about one to about two hours after application to pavement surfaces, and without need for sanding. Sanding refers to the need for broadcasting a layer of sand on the treated surface to aid in the drying of the surface to allow for return to passage of motor vehicle traffic. In some embodiments, the rejuvenating composition dries in about one hour without the need for sanding. In some embodiments, the rejuvenating composition dries in about two hours without the need for sanding.

The rejuvenating composition comprises a dispersion containing a rejuvenating component and a polymeric component. The composition is deposited, e.g., by spraying onto existing asphalt pavements and penetrating into the asphalt binder. The area of the pavement containing the composition achieves a decrease in viscosity similar to what is outlined in the US Army Corps of Engineers (USACE) unified facilities guide specification (UFGS) for bituminous rejuvenation. This specification suggests that the asphalt binder recovered from the upper 9.5 mm of the treated pavement shall exhibit a decrease in viscosity with respect to untreated material.

The composition does not adversely affect the coefficient of friction on treated roads and can be diluted with water in-situ to match the type or grade of pavement to be treated. The material reduces the viscosity of treated pavement binder between about 25% to about 60%. This is beneficial as it returns the binder to close to its original viscoelastic properties.

The composition is non-toxic, and contains no volatile organic compounds (VOCs), either non-exempt or exempt.

In one preferred embodiment, the rejuvenating composition contains a rejuvenating agent, a self-cross-linking polymer, water and a surfactant.

On application to a pavement surface, the composition prevents raveling and intrusion of water into the pavement, thus inhibiting the pavement aging process. The composition also achieves a reduction in permeability.

In one preferred embodiment, the composition comprises a bio based (made from plant material) rejuvenating agent that is a tall oil fatty acid derivative, a self-cross-linking polymer, water and a surfactant.

In one preferred embodiment, the rejuvenating agent is a tall oil fatty acid derivative.

In another preferred embodiment, the tall oil fatty acid derived rejuvenating agent is Sylvaroad™.

In a further embodiment, the composition includes a de-foaming agent.

In a still further embodiment, the composition includes a tinting agent.

In some embodiments, the composition contains more than one surfactant.

In one embodiment, the rejuvenating composition is directly applied to the surface of an asphalt pavement in need of rejuvenation by spraying the composition onto the asphalt surface with a single spray bar.

In another embodiment, the composition can be applied at a rate of between about 0.01 to 0.07 gallons per square yard of asphalt to be treated and preferably between 0.02 and 0.03 gallons per square yard of asphalt to be treated. In another embodiment, the composition can be applied at a rate of between about 0.015 to about 0.03 gallons per square yard of asphalt to be treated. In another embodiment, the composition can be applied at a rate of about 0.02 gallons per square yard.

### BRIEF DESCRIPTION OF THE DRAWINGS

FIG. 1 shows complex modulus [G*] measurements at 60° C. and 10 rad/s of an open grade friction course pavement three months after treatment with exemplary rejuvenating compositions (Composition 2, Composition 3, Composition 4).

FIG. 2 shows complex viscosity measurements at 60° C. of an open grade friction course pavement three months after treatment with exemplary rejuvenating compositions (Composition 2, Composition 3, Composition 4).

FIG. 3 shows complex friction measurements of an open grade friction course pavement at 2 hours, 4 hours, 6 hours, and three months after treatment with exemplary rejuvenating compositions (Composition 3, Composition 5, Composition 2, Composition 6, Composition 4).

### DETAILED DESCRIPTION

As used herein, the term “asphalt” refers to a composite material comprising a bituminous binder and/or bituminous binder and aggregate, which is generally used for paving applications. Such asphalt is also known as “asphalt concrete.” Examples of asphalt grades used in paving applications include stone mastic asphalt, soft asphalt, hot rolled asphalt, dense-graded asphalt, warm mix asphalt, gap-graded asphalt, porous asphalt, mastic asphalt, and other asphalt types. Typically, the total amount of bituminous binder in asphalt is from 1 to 20 wt. % based on the total weight of the asphalt, in some cases from 0.1 to 20.0 wt. %.

As used herein, the term “pavement” means all possible transportation surfaces, and refers to a surface which can be repaired including, aircraft runways and taxiways, roadways, walkways, bicycle paths, curbs, steps, parking lots, oil rig decks, and warehouse floors. “Pavement” may be used interchangeably with “road.”

As used herein, the term “dense graded friction course” asphalt or pavement (DGFC) is an asphalt or pavement that uses densely packed fine-graded or coarse-graded aggregate. It is designed, mixed, and poured to obtain a dense and more impermeable pavement layer. The aggregate is uniformly graded to provide for a stable and impermeable surface. The aggregate can be treated and the asphalt binder can be modified. The asphalt could be made from new or recycled material. Dense graded asphalt is primarily used in climates that frequently encounter cold temperatures, i.e., below 4° C.

As used herein, the term “open graded friction course” (OGFC) asphalt or pavement is a layer of porous asphalt overlaying the surface of impervious hot-mix or dense-graded asphalt. An “open-graded friction course” is defined as a thin, permeable layer of asphalt that integrates a skeleton of uniform aggregate size with a minimum of fines and is often referred to as porous pavement. These mixes contain a small percentage of fine aggregate which produces a large number of air voids. The pavement consists primarily of single size coarse aggregate with a high asphalt content. The aggregate skeleton is responsible for the pavement's ability to resist trucks and carry the loads without undergoing permanent deformation. This aggregate structure provides a higher degree of friction as well as permeability to the surface of the pavement. This permeability further improves frictional behavior during wet weather while reducing the dangers of splash and spray and hydroplaning due to increased drainage from the pavement surface. In addition, open graded friction courses are generally quieter than typical pavements.

As used herein, “rejuvenator” or “rejuvenating component” or “rejuvenating agent” refers to a sprayable, bio-based, non-toxic, composition that can penetrate the surface layer of an asphalt pavement and replace certain oils, e.g., bitumens that may have been lost in the asphalt due to exposure to weather, wear-and-tear, etc. A rejuvenator can penetrate the existing asphalt surface layer, contact the asphalt binder and revitalize the binder's viscoelastic properties, resulting in increased strength and durability of the asphalt pavement being treated.

As used herein, “cyclic content,” refers to the percentage by weight of compounds in the rejuvenating agent that have one or more cycloaliphatic or aromatic rings as part of the structure. Thus, the cyclic content can come from mono-, bi-, tri-, or other polycyclic compounds. The rings can be fused or isolated. The rings are preferably 3-, 4-, 5-, 6-, or 7-membered, with 5- or 6-membered rings being more preferred. The rings may also contain one or more heteroatoms, e.g., oxygen, nitrogen, sulfur, or the like.

As used herein, “treating” refers to the act of applying a rejuvenating composition onto an asphalt surface. The asphalt layer is rejuvenated by the rejuvenating composition.

As used herein, “rejuvenating” or “rejuvenated” refers to the effect on the asphalt surface obtained by interaction of the applied rejuvenating composition and the asphalt. The surface life of an asphalt surface is rejuvenated by restoring the viscoelastic properties of the asphalt binder by altering its rheology. Parameters used to assess rejuvenation include complex modulus and complex viscosity.

As used herein, “rheology” refers to the study of deformation and flow of matter. Deformation and flow of the asphalt binder is important in pavement performance. Pavements that deform and flow too much may be susceptible to rutting and bleeding, while those that are too stiff may be susceptible to fatigue cracking. Pavement deformation is closely related to asphalt binder rheology. Rheological properties of asphalt binder vary with temperature. Rheological properties include relaxation times, viscosity, stress and strain, which can be measured by, e.g., complex modulus, complex viscosity, rotational viscosity, performance grading, delta T_{c}, and phase angle.

As used herein, “complex modulus” (sometimes referred to as Dynamic Modulus) is the ratio of stress to strain under vibratory conditions (calculated from data obtained from either free or forced vibration tests, in shear, compression, or elongation). It is a property of viscoelastic materials. Complex Modulus is the overall resistance to deformation of a material, regardless of whether that deformation is recoverable (elastic) or non-recoverable (viscous). It is often represented by the Symbol G*. This is a useful property to quantify as it is a direct measure of the rigidity of a material's soft solid structure when exposed to stresses below the yield stress. For that reason it is a good indicator of visible attributes such as the flexibility or stiffness of a material. Complex modulus is obtained by performing oscillation rheology techniques.

As used herein, “complex viscosity” is the frequency-dependent viscosity function determined for a viscoelastic material by subjecting it to oscillatory shear stress, and is calculated as the Complex Modulus divided by Angular Frequency. Symbol: η, units: typically pascal-seconds (Pa·s).

As used herein, the “Dynamic Friction Tester” is a portable instrument that measures the frictional characteristics of paved surfaces in laboratories and on roads, highways, airport taxi-ways, runways and other areas. The device assesses the friction of a paved surface. Pavement friction is the force that resists the relative motion between a vehicle tire and a pavement surface.

As used herein, a “dynamic shear rheometer” is used to characterize the viscous and elastic behavior of asphalt binders at medium to high temperatures.

As used herein, a “bending beam rheometer” is used to measure of low temperature stiffness and relaxation properties of asphalt binders. These parameters give an indication of an asphalt binder's ability to resist low temperature cracking.

As used herein, “weight solids” refers to the solid content of a polymer emulsion. It can be determined either by weight of the solids in the emulsion prior to addition of water, i.e., a “100% solids mix”, or can be determined as the dry residue of all solid material after evaporation of water from the polymer emulsion. The vast majority of the “weight solids” comprise the polymer of the polymer emulsion.

In some embodiments, the components are present in the ranges specified (e.g., the term “about” is not present). In some embodiments, “about” refers to ±10% of the value. In some embodiments, “about” refers to ±5% of the value. In some embodiments, “about” refers to ±3% of the value. In some embodiments, “about” refers to ±1% of the value. In some embodiments, the asphalt coating composition is an asphalt rejuvenation composition. In some embodiments, the asphalt rejuvenation composition comprises a rejuvenating agent, a self-cross-linking polymer, water and a surfactant. In some embodiments, the asphalt rejuvenation composition further comprises a de-foaming agent. In some embodiments, the asphalt rejuvenation composition further comprises acetic acid. In some embodiments, the asphalt rejuvenation composition further comprises ethylene glycol. In some embodiments, the asphalt rejuvenation composition further comprises a tinting agent. In some embodiments, the asphalt rejuvenation composition is a rejuvenating composition. In some embodiments, the rejuvenating composition is an asphalt rejuvenating composition. In some embodiments, the rejuvenating composition is a rejuvenator composition. In some embodiments, the rejuvenating composition is an asphalt rejuvenator composition.

The rejuvenating compositions described herein penetrate into the surface pores of asphalt pavement and protect the underlying asphalt structure from further deterioration. The compositions also restore the viscosity profile and skid resistance of the pavement, act to seal small surface cracks and coat aggregate particles beneath the wearing surface.

The rheological properties of aged binder in asphalt pavement are restored by treatment with the rejuvenating compositions disclosed herein. The compositions improve the viscosity and skid resistance of the pavement to which they are applied. In some embodiments, the complex modulus and the complex viscosity of the asphalt pavement are reduced by at least 40% at about three months post-treatment of the pavement with the asphalt rejuvenation composition disclosed herein. In some embodiments, the complex modulus of the asphalt pavement is reduced by at least 40% at about three months post-treatment of the pavement with the asphalt rejuvenation composition. In some embodiments, the complex viscosity of the asphalt pavement is reduced by at least 40% at about three months post-treatment of the pavement with the asphalt rejuvenation composition. In some embodiments, the complex modulus of the asphalt pavement is reduced by at least 50% at about three months post-treatment of the pavement with the asphalt rejuvenation composition. In some embodiments, the complex viscosity of the asphalt pavement is reduced by at least 50% at about three months post-treatment of the pavement with the asphalt rejuvenation compositions disclosed herein.

In some embodiments, the complex modulus of the asphalt pavement is reduced or maintained at about 3, about 4, about 5, about 6, about 7, about 8, about 9, about 10, about 11, about 12, about 13, about 14, about 15, about 16, about 17, about 18, about 19, about 20, about 21, about 22, about 23, or about 24 months post-treatment of the pavement with the asphalt rejuvenation composition. In some embodiments, the complex modulus of the asphalt pavement is reduced or maintained at about 1, about 2, about 3, about 4, about 5, about 6, or about 7 years post-treatment of the pavement with the asphalt rejuvenation composition. In some embodiments, the complex modulus is reduced or maintained on treated pavement subjected to accelerated aging, i.e., via excess heat.

In some embodiments, the complex viscosity of the asphalt pavement is reduced or maintained at about 3, about 4, about 5, about 6, about 7, about 8, about 9, about 10, about 11, about 12, about 13, about 14, about 15, about 16, about 17, about 18, about 19, about 20, about 21, about 22, about 23, or about 24 months post-treatment of the pavement with the asphalt rejuvenation composition. In some embodiments, the complex viscosity of the asphalt pavement is reduced or maintained at about 1, about 2, about 3, about 4, about 5, about 6, or about 7 years post-treatment of the pavement with the asphalt rejuvenation composition. In some embodiments, the complex viscosity is reduced or maintained on treated pavement subjected to accelerated aging, i.e., via excess heat.

In some embodiments, the rotational viscosity of the asphalt pavement is reduced or maintained at about 3, about 4, about 5, about 6, about 7, about 8, about 9, about 10, about 11, about 12, about 13, about 14, about 15, about 16, about 17, about 18, about 19, about 20, about 21, about 22, about 23, or about 24 months post-treatment of the pavement with the asphalt rejuvenation composition. In some embodiments, the rotational viscosity of the asphalt pavement is reduced or maintained at about 1, about 2, about 3, about 4, about 5, about 6, or about 7 years post-treatment of the pavement with the asphalt rejuvenation composition. In some embodiments, the rotational viscosity is reduced or maintained on treated pavement subjected to accelerated aging, i.e., via excess heat.

Other parameters used to assess the effectiveness of the rejuvenation compositions on asphalt pavement include performance grading, delta T_{c}, and phase angle. In some embodiments, at least one of performance grading, delta T_{c}, and phase angle of the asphalt pavement is maintained or improved at about 3, about 4, about 5, about 6, about 7, about 8, about 9, about 10, about 11, about 12, about 13, about 14, about 15, about 16, about 17, about 18, about 19, about 20, about 21, about 22, about 23, or about 24 months post-treatment of the pavement with the asphalt rejuvenation composition. In some embodiments, at least one of performance grading, delta T_{c}, and phase angle of the asphalt pavement is maintained or improved at about 1, about 2, about 3, about 4, about 5, about 6, or about 7 years post-treatment of the pavement with the asphalt rejuvenation composition. In some embodiments, at least one of performance grading, delta T_{c}, and phase angle is maintained or improved on treated pavement subjected to accelerated aging, i.e., via excess heat.

After a period of time post-treatment with the asphalt rejuvenation composition, the rheology of the pavement will return to the control state, i.e., the state of the pavement prior to the initial treatment with the asphalt rejuvenation composition. The period of time for which the pavement rheology returns to the control state is dependent on several factors, including the kind of pavement, weather conditions, and the age of the pavement when treated with the asphalt rejuvenation composition.

In some embodiments, the pavement is re-treated with the asphalt rejuvenation composition after a period of time upon which one or more rheological properties has approached or returned to the state of the pavement prior to the previous treatment with the asphalt rejuvenation composition. In some embodiments, the period of time is between about 1 year to about 7 years. In some embodiments, the period of time is about 1 year. In some embodiments, the period of time is about 2 years. In some embodiments, the period of time is about 3 years. In some embodiments, the period of time is about 4 years. In some embodiments, the period of time is about 5 years. In some embodiments, the period of time is about 6 years. In some embodiments, the period of time is about 7 years.

The asphalt rejuvenation composition may be used to re-treat a pavement in cycles, i.e., the pavement may be re-treated with the asphalt rejuvenation composition multiple times in order to extend the service life of the pavement. In some embodiments, the pavement is re-treated one time with the asphalt rejuvenation composition. In some embodiments, the pavement is re-treated two times with the asphalt rejuvenation composition. In some embodiments, the pavement is re-treated three times with the asphalt rejuvenation composition. In some embodiments, the pavement is re-treated four times with the asphalt rejuvenation composition. In some embodiments, the pavement is re-treated five times with the asphalt rejuvenation composition. In some embodiments, the pavement is re-treated more than five times with the asphalt rejuvenation composition.

Because the rejuvenation compositions described herein are applied by spraying onto the asphalt surface, they dry quickly, usually in less than about one to about two hours. This is of considerable importance as pavement that has been coated with the compositions (e.g., to restore viscosity and skid resistance) can be reopened to vehicle traffic quickly after application of the composition to the pavement surface. This means there are minimal interruptions to the travelling public. A superior combination of properties of the rejuvenating compositions described herein is that the fast drying time accompanied with good rejuvenation properties is accomplished without the need for subsequent sanding and/or the use of volatile organic compounds in the rejuvenating composition.

In contrast to the rejuvenating compositions described herein, other rejuvenating compositions in the art require either subsequent sanding, or the use of volatile organic compounds in the rejuvenating composition to promote drying. In some embodiments, the rejuvenating compositions described herein do not require subsequent sanding to promote drying. In some embodiments, the rejuvenating compositions described herein do not require the use of volatile organic compounds in the rejuvenating composition to promote drying.

Sanding has many disadvantages, including added expense, the additional time and labor required for the sanding operation, the messy road surface conditions created by the presence of the sand coated with rejuvenating material, and the waste of having to scoop away a portion of the rejuvenating agent absorbed by the sand. The performance of the rejuvenating agent is also affected by sanding, as the sand absorbs much of the rejuvenating agent. As a result, rejuvenating compositions which require sand also require much higher application rates than the rejuvenating compositions described herein. For example, the rejuvenating compositions disclosed herein can be applied at rates significantly lower than 0.07 gallons per square yard, whereas other rejuvenating compositions which require sanding are generally applied at rates of at least 0.07 gallons per square yard.

In some embodiments, the rejuvenating composition dries in about one hour without the need for sanding. In some embodiments, the rejuvenating composition dries in about two hours without the need for sanding.

The rejuvenating compositions described herein do not contain any organic asphalt solvents, e.g., VOCs, either non-exempt or exempt, in the interest of environmental and ecological preservation. VOC exempt solvents are organic compounds that are exempt from restrictions placed on most volatile organic compounds (VOCs) in the United States. This class currently includes acetone, dimethyl carbonate, methyl acetate, parachlorobenzotrifluoride (Oxsol 100), tert-Butyl acetate, and propylene carbonate. All solvents that are not on the exempt list are VOCs.

Typical examples of non-exempt volatile organic compounds (VOCs) used asphalt rejuvenations comprise, but not are not limited to mineral spirits, aromatic 100, d-limonene, methyl ethyl ketone (MEK), xylene and toluene.

Typical examples of exempt volatile organic compounds (VOC's) used in asphalt rejuvenations comprise, but not are not limited to parachlorbenzotrifluoride (PCBTF), tertiary butyl acetate, and acetone.

In all embodiments, the rejuvenating compositions disclosed herein do not contain volatile organic compounds.

The friction properties displayed by the rejuvenating compositions disclosed herein demonstrate the ability of the rejuvenating compositions to sufficiently dry in a reasonable period of time to re-open treated roads to traffic without the need for subsequent sanding and/or the use of volatile organic compounds in the rejuvenating composition. In some embodiments, the friction of pavement treated with a rejuvenating composition described herein at between about one hour and 3 months post treatment without sanding is within about 10% of the friction of the pavement prior to treatment. In some embodiments, the friction of pavement treated with a rejuvenating composition described herein at between about one hour and 3 months post treatment without sanding is within about 5% of the friction of the pavement prior to treatment. In some embodiments, the friction of pavement treated with a rejuvenating composition described herein between at about two hours and six hours post treatment without sanding is within about 10% of the friction of the pavement prior to treatment. In some embodiments, the friction of pavement treated with a rejuvenating composition described herein at between about two hours and six hours post treatment without sanding is within about 5% of the friction of the pavement prior to treatment. In some embodiments, the friction of pavement treated with a rejuvenating composition described herein at about one hour post treatment without sanding is within about 10% of the friction of the pavement prior to treatment. In some embodiments, the friction of pavement treated with a rejuvenating composition described herein at about one hour post treatment without sanding is within about 5% of the friction of the pavement prior to treatment. In some embodiments, the friction of pavement treated with a rejuvenating composition described herein at about two hours post treatment without sanding is within about 10% of the friction of the pavement prior to treatment. In some embodiments, the friction of pavement treated with a rejuvenating composition described herein at about two hours post treatment without sanding is within about 5% of the friction of the pavement prior to treatment. In some embodiments, the friction of pavement treated with a rejuvenating composition described herein at about three hours post treatment without sanding is within about 10% of the friction of the pavement prior to treatment. In some embodiments, the friction of pavement treated with a rejuvenating composition described herein at about three hours post treatment without sanding is within about 5% of the friction of the pavement prior to treatment. In some embodiments, the friction of pavement treated with a rejuvenating composition described herein at about four hours post treatment without sanding is within about 10% of the friction of the pavement prior to treatment. In some embodiments, the friction of pavement treated with a rejuvenating composition described herein at about four hours post treatment without sanding is within about 5% of the friction of the pavement prior to treatment. In some embodiments, the friction of pavement treated with a rejuvenating composition described herein at about five hours post treatment without sanding is within about 10% of the friction of the pavement prior to treatment. In some embodiments, the friction of pavement treated with a rejuvenating composition described herein at about five hours post treatment without sanding is within about 5% of the friction of the pavement prior to treatment. In some embodiments, the friction of pavement treated with a rejuvenating composition described herein at about six hours post treatment without sanding is within about 10% of the friction of the pavement prior to treatment. In some embodiments, the friction of pavement treated with a rejuvenating composition described herein at about six hours post treatment without sanding is within about 5% of the friction of the pavement prior to treatment.

In some embodiments, the asphalt rejuvenation compositions disclosed herein comprise a rejuvenating agent, a self-cross-linking polymer, water and a surfactant. In some embodiments, the asphalt rejuvenation compositions further comprise a de-foaming agent. In some embodiments, the asphalt rejuvenation compositions further comprise acetic acid. In some embodiments, the asphalt rejuvenation composition further comprise ethylene glycol. In some embodiments, the asphalt rejuvenation compositions further comprise a tinting agent.

A rejuvenating agent reverses the impact of aging on asphalt performance, properties and durability; extending the service life, protecting and restoring the pavement for the future. To address environmental concerns preferred rejuvenating agents are bio-based. Bio-based means the ingredients are made using plant based materials.

In one embodiment, the rejuvenation composition is not toxic to humans, and derives from tall oil, e.g., a tall oil fatty acid or a tall oil fatty acid derivative (e.g., a tall oil fatty acid dimer acid). Tall oil fatty acid is isolated from crude tall oil by distillation. The crude tall oil is a by-product of the Kraft wood pulping process. Distillation of crude tall oil gives, in addition to tall oil fatty acid, a more volatile, highly saturated fraction of long-chain fatty acids (largely palmitic acid), known as “tall oil heads.” Tall oil fatty acid is the next cut, which contains mostly C18 and C20 fatty acids having varying degrees of unsaturation (e.g., oleic acid, linoleic acid, linolenic acid, and various isomers of these). Another cut, known as distilled tall oil is a mixture of mostly tall oil fatty acid and a smaller proportion of tall oil rosin. Tall oil rosin isolated next, consists largely of a C19-C20 tricyclic monocarboxylic acid. The bottom cut of the distillation is known as “tall oil pitch” or simply “pitch.” Generally, any cut that contains at least some tall oil fatty acid is preferred for use in making an ester-functional rejuvenating agent.

In some embodiments, the rejuvenating agent comprises a tall oil-derived fatty ester, a rosin ester, or a mixture thereof. In some embodiments, the rejuvenating agent comprises a tall oil-derived fatty ester. In some embodiments, the rejuvenating agent comprises a tall oil fatty acid derivative. In some embodiments, the tall oil fatty acid derivative is a tall oil-derived fatty ester. In some embodiments, the tall oil-derived fatty ester comprises a fatty acid portion and an alcohol portion. In some embodiments, the rejuvenating agent has a cyclic content of at least 5 wt. %. In some embodiments, the rejuvenating agent has a cyclic content of at least 10 wt. %. In some embodiments, the rejuvenating agent has a cyclic content of about 5 wt. % to about 95 wt. %. In some embodiments, the rejuvenating agent has a cyclic content of about 10 wt. % to about 90 wt. %.

The rejuvenating agent may also comprise an ester from a fatty acid monomer, dimer or trimer. Fatty acid monomers are obtained as a by-product of the processes used to dimerize or polymerize unsaturated fatty acids. Unsaturated fatty acids are commonly polymerized using acid clay catalysts. Fatty acids having high levels of mono- or polyunsaturation are preferred. In this high-temperature process, the unsaturated fatty acids undergo intermolecular addition reactions by, e.g., the “ene reaction,” to form polymerized fatty acids. The mechanism is complex and not well understood. However, the product comprises mostly dimerized fatty acid and a unique mixture of monomeric fatty acids. Distillation provides a fraction highly enriched in dimerized fatty acid, which is commonly known as “dimer acid.” Such dimer acids are suitable for use in making the ester-functional rejuvenating agents.

In some embodiments, the rejuvenating agent comprises, in addition to the ester or ester blend, a polyterpene, a terpene phenol, a tall oil pitch, a tall oil pitch derivative, a sterol, an alkylated phenol, or an α-methylstyrene polymer.

The distillation of polymerized tall oil fatty acid (TOFA) provides a fraction that is highly enriched in monomeric fatty acids and is known as “Monomer” (with a capital “M”) or “Monomer acid.” Monomer, a unique composition, is a preferred starting material for making ester-functional rejuvenating agents. Whereas natural source-derived TOFA largely consists of linear C18 unsaturated carboxylic acids, principally oleic and linoleic acids, Monomer contains relatively small amounts of oleic and linoleic acids, and instead contains significant amounts of branched and cyclic C18 acids, saturated and unsaturated, as well as elaidic acid. The more diverse and significantly branched composition of Monomer results from the catalytic processing carried out on TOFA during polymerization. The art recognizes that the reaction of Monomer with alcohols to make “Monomerate” esters will yield unique derivatives that differ from the corresponding TOFA-based esters. Monomer has been assigned CAS Registry Number 68955-98-6. Examples of Monomer products are Century® MO5 and MO6 fatty acids, products of Arizona Chemical Company. For more information about the composition of Monomer and its conversion to various esters, see U.S. Pat. No. 7,256,162, the teachings of which are incorporated herein by reference. Specific examples of suitable ester-functional rejuvenating agents from monomer, dimer, and trimer fatty acids include, for example, ethylene glycol Monomerate, glycerol Monomerate, trimethylolpropane Monomerate, neopentyl glycol Monomerate, 2-ethylhexyl Monomerate, ethylene glycol dimerate, 2-ethylhexyl dimerate, 2-ethylhexyl trimerate, and the like.

In one embodiment, the ester-functional rejuvenating agent for the asphalt rejuvenating composition derives from one or more improved thermal stability alcohols. As used herein, “improved thermal stability alcohol,” is an alcohol that has a quaternary carbon located beta to the oxygen of any of its hydroxyl groups. Examples include trimethylolethane, trimethylolpropane, neopentyl glycol, pentaerythritol, dipentaerythritol, benzylic alcohols, and the like, and mixtures thereof. In particular, we found that rejuvenating agents in which at least part of the ester component derives from an improved thermal stability alcohol give rejuvenating agents with desirably low cloud points (preferably less than −20° C.), low pour points (preferably less than −30° C.), and good to excellent low-temperature properties.

The tall oil fatty acid derivative rejuvenating agent of the present disclosure has an acid portion comprising C8-C20 fatty acids with some degree (often a high degree) of unsaturation. The fatty acid can be in a polymerized form, as in dimerized fatty acid mixtures, such as for example oleic acid, linolenic acid, and palmitic acid; as well as monomer acid, dimer acids, tall oil heads, and the like, and mixtures thereof. The alcohol portion of the rejuvenating agent can be primary, secondary, or tertiary; it can be a monol, diol, or polyol.

In some embodiments, the rejuvenating agent comprises a rosin ester. In some embodiments, the rosin ester comprises a rosin acid portion and an alcohol portion. In some embodiments, the rosin acid may be used in isolated form, or as part of a composition which may comprise a plurality of rosin acids. In some embodiments, rosin may be used as a source of rosin acid. Rosin is a hydrocarbon secretion of many plants, particularly coniferous trees such as Pinus palustris and Pinus caribaea. Natural rosin typically consists of a mixture of seven or eight rosin acids, and other minor components. Rosin is commercially available and can be obtained from pine trees by distillation of oleoresin (gum rosin being the residue of distillation), by extraction of pine stumps (wood rosin) or by fractionation of tall oil (tall oil rosin). Any type of rosin may be used, including tall oil rosin, gum rosin and wood rosin. Tall oil rosin is typically used because of its availability. Examples of suitable commercially available rosins include tall oil rosins (e.g., Sylvaros® 85, Sylvaros® 90 or Sylvaros® 95 from Arizona Chemical).

In some embodiments, the tall oil-derived fatty ester, rosin ester, or combination thereof, may comprise some residual, unreacted acid and alcohol. In some embodiments, the tall oil-derived fatty ester, rosin ester, or combination thereof, has an acid number below 20 mg KOH/g. In some embodiments, the tall oil-derived fatty ester, rosin ester, or combination thereof, has an acid number below 15 mg KOH/g. The acid number may be determined by methods known to the skilled person, such as the standard method ASTM D974 which uses a color-indicator titration.

The rejuvenator is used in combination with a polymer. The amount of rejuvenator to polymer ranges from 20:80 to 80:20 by weight with the polymer being selected from elastomers or plastomers suitable for asphalt applications, including but not limited to acrylics and stabilized acrylic dispersions. In some embodiments, the amount of rejuvenator to polymer ranges from about 20:20 to about 60:20 by weight. In some embodiments, the amount of rejuvenator to polymer is about 20:20 by weight. In some embodiments, the amount of rejuvenator to polymer is about 30:20 by weight. In some embodiments, the amount of rejuvenator to polymer is about 40:20 by weight. In some embodiments, the amount of rejuvenator to polymer is about 50:20 by weight. In some embodiments, the amount of rejuvenator to polymer is about 60:20 by weight. The rejuvenator can be used in a dispersion system in an amount from 5-70 wt. % of the asphalt rejuvenation composition. The polymer is preferably a self-cross-linking agent.

One preferred bio-based rejuvenating agent for use in the pavement rejuvenating compositions disclosed herein is a tall oil fatty acid (TOFA) derived from crude tall oil. The preferred TOFA is Sylvaroad™ RP-1000 (Arizona Chemical/Kraton). This Tall Oil derived material is 100% bio-based and free from VOCs. Other preferred bio-based rejuvenating agents that can be used in the pavement rejuvenating compositions disclosed herein are Anova 1845 and Anova 1815 (Cargill) which are chemically derived from vegetable oils.

In some embodiments, the tall oil fatty acid derivative has a cyclic content of at least 5 wt. %. In some embodiments, the tall oil fatty acid derivative has a cyclic content of at least 10 wt. %. In some embodiments, the tall oil fatty acid derivative has a cyclic content of about 5 wt. % to about 95 wt. %. In some embodiments, the tall oil fatty acid derivative has a cyclic content of about 10 wt. % to about 90 wt. %. In some embodiments, the tall oil-derived fatty ester has a cyclic content of at least 5 wt. %. In some embodiments, the tall oil-derived fatty ester has a cyclic content of at least 10 wt. %. In some embodiments, the tall oil-derived fatty ester has a cyclic content of about 5 wt. % to about 95 wt. %. In some embodiments, the tall oil-derived fatty ester has a cyclic content of about 10 wt. % to about 90 wt. %. In some embodiments, the tall oil fatty acid derivative is Sylvaroad™. In some embodiments, the tall oil fatty acid derivative is Sylvaroad™ RP-1000. In some embodiments, the tall oil-derived fatty ester is Sylvaroad™. In some embodiments, the tall oil-derived fatty ester is Sylvaroad™ RP-1000.

In some embodiments, the rejuvenating agent is a biorenewable oil. In some embodiments, the rejuvenating agent is a previously modified or functionalized biorenewable oil. Examples of previously modified oils are those that have been previously vulcanized or polymerized by other polymerizing technologies, such as maleic anhydride or acrylic acid modified, hydrogenated, dicyclopentadiene modified, conjugated via reaction with iodine, interesterified, or processed to modify acid value, hydroxyl number, or other properties. Some examples of previously modified oils are polyol esters, for example polyglycerol ester or a castor oil ester, or estolides. Such modified oils can be blended with unmodified plant-based oils or animal-based oils, fatty acids, glycerin, and/or lecithin as a modified oil blend. Examples of functionalized oils are those wherein a heteroatom (oxygen, nitrogen, sulfur, and phosphorus) has been introduced. In some embodiments, the rejuvenating agent is a modified oil blend. In some embodiments, the modified oil blend is a blend of a modified biorenewable oil with soybean oil.

In some embodiments, the rejuvenating agent is a hydrocarbon oil, for example, petroleum hydrocarbons, animal/plant oils and fats, synthetic hydrocarbons, and synthetic esters. In one embodiment, the hydrocarbon oil is a petroleum hydrocarbon. In some embodiments, the hydrocarbon oil is a heavy hydrocarbon oil having a flashpoint higher than approximately 200° C. In some embodiments, the hydrocarbon oil is Tudalen 65, a hydrocarbon flux oil (H&R Group); Rheofalt HP-EM, rejuvenating agent comprising cardanon, which is a long chain unsaturated alkylate of a phenol (Ventraco Chemie); or Cenwax G—a hydrogenated castor oil (Arizona Chemical Company).

In some embodiments, the rejuvenating agent can be a petroleum based oil, such as naphthenic oils, or sustainably sourced oil such as a plant-based oil, or a vegetable-based oil. Suitable plant oils can include tall oil, corn oil, canola oil, soy oil, biodiesel oils, nut oils, nut shell oils, nut shell liquids, and nut shell liquid pitch. Non-limiting, examples of bio-based rejuvenating agents include one or more of a vegetable oil or ester thereof, a seed oil or ester thereof, a soybean oil or ester thereof, a corn oil or ester thereof, a palm oil or ester thereof, a canola oil or ester thereof, a safflower oil or ester thereof, a sunflower oil or ester thereof, a citrus oil or ester thereof, pine oil or ester thereof, a rosin oil or ester thereof, or a bio-based fatty acid ester.

In some embodiments, the rejuvenating agent is a mixture of different rejuvenating agents, e.g., a mixture of castor oil based rejuvenator in combination with an ester-functional rejuvenating agent derived from tall oil.

In some embodiments, the rejuvenating agent is present in an amount of about 15% to about 45% by weight of the asphalt rejuvenation composition. In some embodiments, the rejuvenating agent is present in an amount of about 20% to about 40% by weight of the asphalt rejuvenation composition. In some embodiments, the rejuvenating agent is present in an amount of about 23% to about 35% by weight of the asphalt rejuvenation composition. In some embodiments, the rejuvenating agent is present in an amount of about 23% by weight of the asphalt rejuvenation composition. In some embodiments, the rejuvenating agent is present in an amount of about 24% by weight of the asphalt rejuvenation composition. In some embodiments, the rejuvenating agent is present in an amount of about 25% by weight of the asphalt rejuvenation composition. In some embodiments, the rejuvenating agent is present in an amount of about 26% by weight of the asphalt rejuvenation composition. In some embodiments, the rejuvenating agent is present in an amount of about 27% by weight of the asphalt rejuvenation composition. In some embodiments, the rejuvenating agent is present in an amount of about 28% by weight of the asphalt rejuvenation composition. In some embodiments, the rejuvenating agent is present in an amount of about 29% by weight of the asphalt rejuvenation composition. In some embodiments, the rejuvenating agent is present in an amount of about 30% by weight of the asphalt rejuvenation composition. In some embodiments, the rejuvenating agent is present in an amount of about 31% by weight of the asphalt rejuvenation composition. In some embodiments, the rejuvenating agent is present in an amount of about 32% by weight of the asphalt rejuvenation composition. In some embodiments, the rejuvenating agent is present in an amount of about 33% by weight of the asphalt rejuvenation composition. In some embodiments, the rejuvenating agent is present in an amount of about 34% by weight of the asphalt rejuvenation composition. In some embodiments, the rejuvenating agent is present in an amount of about 35% by weight of the asphalt rejuvenation composition.

The preferred polymers for use in the rejuvenating compositions disclosed herein are self-cross-linking polymers. The self-cross-linking polymers for use in the compositions described herein are preferably cationic acrylic resin products that are often used as binders in paint compositions.

In some embodiments, the self-cross-linking polymer is in an acrylic polymer emulsion. In some embodiments, the acrylic polymer emulsion comprises the self-cross-linking polymer, an emulsion surfactant, and water. In some embodiments, the acrylic polymer emulsion is a ‘standard’ acrylic or styrenated acrylic emulsion using a combination of methyl methacrylate (MMA) monomer and butyl acrylate (BA) monomer with or without styrene. Other regularly used acrylic monomers are ethyl acrylate, 2-ethyl hexyl acrylate and butyl methacrylate. In some embodiments, a surfactant is used in making the acrylic emulsion. In some embodiments, the surfactant used to make the acrylic emulsion is selected from succinates and alkyl chains capped with ethylene oxide. Non-limiting examples of self-cross-linking polymers in emulsions include Acrycote® AP-6091 and Acrolyte AC-300 (Apec. Ltd.); Crilat 4896, a pure acrylic water based polymer dispersion, characterized by cationic emulsifying system and very small particles size (Vinavil); Ecronova RA160 Plus, a water-based cationic emulsion of an acrylic copolymer, and 180 Plus, a water-based cationic emulsion of an acrylic copolymer (Michelman); Ecrylic RA 155 A Plus, an aqueous dispersion of cationic acrylic acid ester/methacrylic acid copolymer (Michelman); Mowinyl 7820, an acrylic resin emulsion (Nippon Gohsei); MyCroFence AM 215, a cationic acrylic resin (Croda); Neocryl XK-30, an acrylic emulsion, or XK-350, an acrylic copolymer emulsion (DSM); Ottopol K-12, an acrylic emulsion polymer, K-12T, an acrylic polymer emulsion, K-21-30, an acrylic polymer, K-23, an alkali resistant cationic acrylic copolymer emulsion, K-65, a hard cationic acrylic emulsion, K-362, K-633, KX-99, and KX-101 (Gellner Industrial LLC); Prox AM 219 RG, Prox AM 270R, and Prox SBP 604 (Synthron); Syntran 6301 and 6301 (Interpolymer); Voncoat SFC-55 (DIC); WorleeCryl 7712 (Worlee); and Vinyblan 2687 (Nissin Chemical Industry). These are useful as self-cross-linking polymers in the pavement rejuvenation compositions described herein.

In some embodiments, the self-cross-linking polymer is the acrylic polymer in the acrylic polymer emulsion. In some embodiments, the self-cross-linking polymer is in an acrylic polymer emulsion comprising MMA, BA, an emulsion surfactant, and water. In some embodiments, the self-cross-linking polymer comprises MMA monomer and BA monomer. In some embodiments, the emulsion surfactant comprises alkyl ethyloxylates. In some embodiments, the emulsion surfactant comprises succinates. In some embodiments, the MMA, BA, and emulsion surfactant are premixed then added to water to emulsify them. In some embodiments, the acrylic polymer emulsion falls in the weight solids range of about 40% to about 70%. In some embodiments, the weight solids of the acrylic polymer emulsion comprise the self-cross-linking polymer and the emulsion surfactant. In some embodiments, the 100% solids mix of the acrylic polymer emulsion prior to emulsification comprises the self-cross-linking polymer and the emulsion surfactant. In some embodiments, the self-cross-linking polymer is the acrylic polymer in the acrylic polymer emulsion. In some embodiments, the weight solids of the acrylic polymer emulsion are about 40%. In some embodiments, the weight solids of the acrylic polymer emulsion are about 43%. In some embodiments, the weight solids of the acrylic polymer emulsion are about 45%. In some embodiments, the weight solids of the acrylic polymer emulsion are about 50%. In some embodiments, the weight solids of the acrylic polymer emulsion are about 55%. In some embodiments, the weight solids of the acrylic polymer emulsion are about 60%. In some embodiments, the weight solids of the acrylic polymer emulsion are about 65%. In some embodiments, the weight solids of the acrylic polymer emulsion are about 70%.

In some embodiments, the self-linking-cross polymer is in an acrylic polymer emulsion comprising an acrylic polymer, an emulsion surfactant and water, wherein the acrylic polymer comprises a combination of methylmethacrylate monomer and butyl acrylate monomer. In some embodiments, the self-linking-cross polymer is in an acrylic polymer emulsion comprising an acrylic polymer, an emulsion surfactant and water, wherein the acrylic polymer comprises a combination of methylmethacrylate monomer and butyl acrylate monomer, and wherein the emulsion surfactant comprises alkyl ethyloxylates. In some embodiments, the self-linking-cross polymer is in an acrylic polymer emulsion comprising an acrylic polymer, an emulsion surfactant, and water, wherein the acrylic polymer comprises a combination of methylmethacrylate monomer and butyl acrylate monomer, and wherein the emulsion surfactant comprises succinates. In some embodiments, the self-linking-cross polymer is the acrylic polymer in the acrylic polymer emulsion.

In some embodiments, the 100% solids mix of the acrylic polymer emulsion prior to emulsification comprises:
about 35 wt. % to about 85 wt. % of MMA;
about 30 wt % to about 80 wt. % of BA; and
about 0.1 wt. % to about 5 wt. % of alkyl ethyloxylates.

In some embodiments, the 100% solids mix of the acrylic polymer emulsion prior to emulsification comprises:
about 45 wt. % to about 65 wt. % of MMA;
about 40 wt. % to about 60 wt. % of BA; and
about 0.1 wt. % to about 3 wt. % of succinates.

In some embodiments, the weight solids of the acrylic polymer emulsion comprise about 95% to about 99.9% of the self-cross-linking polymer. In some embodiments, the acrylic polymer emulsion comprising the self-cross-linking polymer is Ottopol K12T. In some embodiments, the Ottopol K12T has about 43% of weight solids.

In some embodiments, the weight solids of the acrylic polymer emulsion comprise about 97% to about 99.9% of the self-cross-linking polymer. In some embodiments, the main acrylic monomer used for the acrylic polymer emulsion is ethylene glycol dimethacrylate (EGDMA). In some embodiments, the 100% solids mix of the acrylic polymer emulsion prior to emulsification comprises about 1 wt. % to about 20 wt. % of EDGMA. In some embodiments, the 100% solids mix of the acrylic polymer emulsion prior to emulsification comprises about 2 wt. % to about 5 wt. % of EDGMA. In some embodiments, the acrylic polymer emulsion comprising the self-cross-linking polymer is Ottopol A-1320. In some embodiments, the Ottopol A-1320 has about 50% of weight solids.

In some embodiments, the self-cross-linking polymer is present in an amount of about 35% to about 70% by weight of the acrylic polymer emulsion. In some embodiments, the self-cross-linking polymer is present in an amount of about 35% to about 50% by weight of the acrylic polymer emulsion. In some embodiments, the self-cross-linking polymer is present in an amount of about 35% by weight of the acrylic polymer emulsion. In some embodiments, the self-cross-linking polymer is present in an amount of about 36% by weight of the acrylic polymer emulsion. In some embodiments, the self-cross-linking polymer is present in an amount of about 37% by weight of the acrylic polymer emulsion. In some embodiments, the self-cross-linking polymer is present in an amount of about 38% by weight of the acrylic polymer emulsion. In some embodiments, the self-cross-linking polymer is present in an amount of about 39% by weight of the acrylic polymer emulsion. In some embodiments, the self-cross-linking polymer is present in an amount of about 40% by weight of the acrylic polymer emulsion. In some embodiments, the self-cross-linking polymer is present in an amount of about 41% by weight of the acrylic polymer emulsion. In some embodiments, the self-cross-linking polymer is present in an amount of about 42% by weight of the acrylic polymer emulsion. In some embodiments, the self-cross-linking polymer is present in an amount of about 43% by weight of the acrylic polymer emulsion. In some embodiments, the self-cross-linking polymer is present in an amount of about 44% by weight of the acrylic polymer emulsion. In some embodiments, the self-cross-linking polymer is present in an amount of about 45% by weight of the acrylic polymer emulsion. In some embodiments, the self-cross-linking polymer is present in an amount of about 46% by weight of the acrylic polymer emulsion. In some embodiments, the self-cross-linking polymer is present in an amount of about 47% by weight of the acrylic polymer emulsion. In some embodiments, the self-cross-linking polymer is present in an amount of about 48% by weight of the acrylic polymer emulsion. In some embodiments, the self-cross-linking polymer is present in an amount of about 49% by weight of the acrylic polymer emulsion. In some embodiments, the self-cross-linking polymer is present in an amount of about 50% by weight of the acrylic polymer emulsion. In some embodiments, the self-cross-linking polymer is present in an amount of about 55% by weight of the acrylic polymer emulsion. In some embodiments, the self-cross-linking polymer is present in an amount of about 60% by weight of the acrylic polymer emulsion. In some embodiments, the self-cross-linking polymer is present in an amount of about 65% by weight of the acrylic polymer emulsion. In some embodiments, the self-cross-linking polymer is present in an amount of about 70% by weight of the acrylic polymer emulsion.

In some embodiments, the self-cross-linking polymer is present in an amount of about 5% to about 45% by weight of the asphalt rejuvenation composition. In some embodiments, the self-cross-linking polymer is present in an amount of about 5% to about 25% by weight of the asphalt rejuvenation composition. In some embodiments, the self-cross-linking polymer is present in an amount of about 8% to about 20% by weight of the asphalt rejuvenation composition. In some embodiments, the self-cross-linking polymer is present in an amount of about 8% by weight of the asphalt rejuvenation composition. In some embodiments, the self-cross-linking polymer is present in an amount of about 8% by weight of the asphalt rejuvenation composition. In some embodiments, the self-cross-linking polymer is present in an amount of about 9% by weight of the asphalt rejuvenation composition. In some embodiments, the self-cross-linking polymer is present in an amount of about 10% by weight of the asphalt rejuvenation composition. In some embodiments, the self-cross-linking polymer is present in an amount of about 11% by weight of the asphalt rejuvenation composition. In some embodiments, the self-cross-linking polymer is present in an amount of about 12% by weight of the asphalt rejuvenation composition. In some embodiments, the self-cross-linking polymer is present in an amount of about 13% by weight of the asphalt rejuvenation composition. In some embodiments, the self-cross-linking polymer is present in an amount of about 14% by weight of the asphalt rejuvenation composition. In some embodiments, the self-cross-linking polymer is present in an amount of about 15% by weight of the asphalt rejuvenation composition. In some embodiments, the self-cross-linking polymer is present in an amount of about 16% by weight of the asphalt rejuvenation composition. In some embodiments, the self-cross-linking polymer is present in an amount of about 17% by weight of the asphalt rejuvenation composition. In some embodiments, the self-cross-linking polymer is present in an amount of about 18% by weight of the asphalt rejuvenation composition. In some embodiments, the self-cross-linking polymer is present in an amount of about 19% by weight of the asphalt rejuvenation composition. In some embodiments, the self-cross-linking polymer is present in an amount of about 20% by weight of the asphalt rejuvenation composition. In some embodiments, the weight percent of the self-cross-linking polymer is representative of the weight solids present in the acrylic polymer emulsion, and does not include the water present in the acrylic polymer emulsion. In some embodiments, the acrylic polymer emulsion is about 40% to about 70% polymer in water. In some embodiments, the acrylic polymer emulsion is about 43% polymer in water. In some embodiments, the acrylic polymer emulsion is about 50% polymer in water. In some embodiments, the self-cross-linking polymer weight is based on the weight solids of the acrylic polymer emulsion. In some embodiments, the % by weight of the self-cross-linking polymer is based on the weight of the acrylic polymer emulsion. In some embodiments, the % by weight of the self-cross-linking polymer is based on the weight of the weight solids of the acrylic polymer emulsion. In some embodiments, the actual weight % of the self-cross-linking polymer is based on the weight of the weight solids of the acrylic polymer emulsion. In some embodiments, the self-cross-linking polymer is present in an amount of about 5% to about 45% by weight of the asphalt rejuvenation composition, based on the weight solids of the acrylic polymer emulsion comprising the self-cross-linking polymer. In some embodiments, the weight solids of the acrylic polymer emulsion comprise about 97% to about 99.9% of the self-cross-linking polymer.

The rejuvenating compositions disclosed herein include at least one surfactant. In some embodiments, the asphalt rejuvenation composition comprises one surfactant. In some embodiments, the asphalt rejuvenation composition comprises two surfactants. In one embodiment, the surfactant is an alkoxylated fatty amine. The term “fatty amine” as used herein includes amines, diamines, and polyamines. The fatty amine can be an ethoxylated fatty amine, a propoxylated fatty amine, a butoxylated fatty amine, and mixtures thereof. One preferred surfactant is a tetramethyldecynediol in ethylene glycol (available as Surfynol 104H from PalmerHolland, North Olmsted Ohio). Other surfactants useful in the rejuvenating compositions described herein include non-ionic nonylphenol ethoxylates such as Brosurf NP-6 (FBC Chemical Corporation), and alkyl phenol ethoxylates such as Tergitol NP-6 (Dow). In some embodiments, a surfactant is a first surfactant. In some embodiments, a surfactant is a second surfactant.

In some embodiments, the surfactant comprises one or more surfactants. In some embodiments, the surfactant comprises a first surfactant and a second surfactant.

In some embodiments, the first surfactant is present in an amount of about 2% to about 10% by weight of the asphalt rejuvenation composition. In some embodiments, the first surfactant is present in an amount of about 3% to about 8.5% by weight of the asphalt rejuvenation composition. In some embodiments, the first surfactant is present in an amount of about 4% to about 7% by weight of the asphalt rejuvenation composition. In some embodiments, the first surfactant is present in an amount of about 4% by weight of the asphalt rejuvenation composition. In some embodiments, the first surfactant is present in an amount of about 5% by weight of the asphalt rejuvenation composition. In some embodiments, the first surfactant is present in an amount of about 6% by weight of the asphalt rejuvenation composition. In some embodiments, the first surfactant is present in an amount of about 7% by weight of the asphalt rejuvenation composition. In some embodiments, the first surfactant is Brosurf NP-6.

In some embodiments, the second surfactant is present in an amount of about 0.05% to about 2.5% by weight of the asphalt rejuvenation composition. In some embodiments, the second surfactant is present in an amount of about 0.1% to about 1% by weight of the asphalt rejuvenation composition. In some embodiments, the second surfactant is present in an amount of about 0.1% to about 0.5% by weight of the asphalt rejuvenation composition. In some embodiments, the second surfactant is present in an amount of about 0.1% by weight of the asphalt rejuvenation composition. In some embodiments, the second surfactant is present in an amount of about 0.2% by weight of the asphalt rejuvenation composition. In some embodiments, the second surfactant is present in an amount of about 0.3% by weight of the asphalt rejuvenation composition. In some embodiments, the second surfactant is present in an amount of about 0.4% by weight of the asphalt rejuvenation composition. In some embodiments, the second surfactant is present in an amount of about 0.5% by weight of the asphalt rejuvenation composition. In some embodiments, the second surfactant is Surfynol 104H.

The pavement rejuvenating compositions disclosed herein may also contain de-foaming agents. Preferred are de-foaming agents that possess high surface activity. In one embodiment, the de-foaming agent is a mixture of hydrophobic solids and foam destroying polysiloxanes in polyglycol (e.g., BYK 022 available from BYK Chemie GmBH-Wesel Germany).

In some embodiments, the de-foaming agent is present in an amount of about 0.05% to about 2.5% by weight of the asphalt rejuvenation composition. In some embodiments, the de-foaming agent is present in an amount of about 0.1% to about 1% by weight of the asphalt rejuvenation composition. In some embodiments, the de-foaming agent is present in an amount of about 0.1% to about 0.5% by weight of the asphalt rejuvenation composition. In some embodiments, the de-foaming agent is present in an amount of about 0.1% by weight of the asphalt rejuvenation composition. In some embodiments, the de-foaming agent is present in an amount of about 0.2% by weight of the asphalt rejuvenation composition. In some embodiments, the de-foaming agent is present in an amount of about 0.3% by weight of the asphalt rejuvenation composition. In some embodiments, the de-foaming agent is present in an amount of about 0.4% by weight of the asphalt rejuvenation composition. In some embodiments, the de-foaming agent is present in an amount of about 0.5% by weight of the asphalt rejuvenation composition. In some embodiments, the de-foaming agent is BYK 022.

In some embodiments, the asphalt rejuvenation composition comprises acetic acid. In some embodiments, the acetic acid is in an aqueous solution. In some embodiments, the acetic acid is 28% acetic acid in water. In some embodiments, the acetic acid is present in an amount of about 0.01% to about 1% by weight of the asphalt rejuvenation composition. In some embodiments, the acetic acid is present in an amount of about 0.08% to about 0.5% by weight of the asphalt rejuvenation composition. In some embodiments, the acetic acid is present in an amount of about 0.1% to about 0.3% by weight of the asphalt rejuvenation composition. In some embodiments, the acetic acid is present in an amount of about 0.1% by weight of the asphalt rejuvenation composition. In some embodiments, the acetic acid is present in an amount of about 0.2% by weight of the asphalt rejuvenation composition. In some embodiments, the acetic acid is present in an amount of about 0.3% by weight of the asphalt rejuvenation composition. In some embodiments, the acetic acid is present in an amount of about 0.01% to about 0.1% by weight of the asphalt rejuvenation composition. In some embodiments, the acetic acid is present in an amount of about 0.03% to about 0.06% by weight of the asphalt rejuvenation composition. In some embodiments, the acetic acid is present in an amount of about 0.03% by weight of the asphalt rejuvenation composition. In some embodiments, the acetic acid is present in an amount of about 0.04% by weight of the asphalt rejuvenation composition. In some embodiments, the acetic acid is present in an amount of about 0.05% by weight of the asphalt rejuvenation composition. In some embodiments, the acetic acid is present in an amount of about 0.06% by weight of the asphalt rejuvenation composition. In some embodiments, the weight percent of the acetic acid is representative of the acetic acid present in the aqueous solution, and does not include the water present in the acetic acid aqueous solution. In some embodiments, the acetic acid weight is based on the acetic acid present in the aqueous solution. In some embodiments, the % by weight of acetic acid is based on the weight of the acetic acid aqueous solution. In some embodiments, the % by weight of acetic acid is based on the weight of the acetic acid present in the aqueous solution. In some embodiments, the actual weight % of acetic acid is based on the weight of the acetic acid present in the aqueous solution.

In some embodiments, the water is present in an amount of about 45% to about 75% by weight of the asphalt rejuvenation composition. In some embodiments, the water is present in an amount of about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75%, by weight of the asphalt rejuvenation composition. In some embodiments, a portion of the water in the asphalt rejuvenation composition is derived from the water in the self-cross-linking polymer emulsion. In some embodiments, a portion of the water in the asphalt rejuvenation composition is derived from the water in the acetic acid solution. In some embodiments, the % by weight of water is based on the weight of the water added to the asphalt rejuvenation composition. In some embodiments, the % by weight of water is based on the weight of the water added to the asphalt rejuvenation composition and the water present in the acrylic polymer emulsion, and the water present in the acetic acid aqueous solution. In some embodiments, the actual weight % of water is based on the weight of the water added to the asphalt rejuvenation composition and the water present in the acrylic polymer emulsion, and the water present in the acetic acid aqueous solution.

The rejuvenating compositions described herein can include tinting agents such as pigments without negatively affecting the performance of the material. For instance, if a “black” color is required to enhance the “curb appeal” of a pavement surface—this can be achieved by adding pigment such as carbon black to the material during the manufacturing operation. The rejuvenating compositions described herein allow for the ability to customize the solution based on color or allow for a clear composition. Other bio-based products do not have tinted compositions or the ability to customize based on color. Other classes, such as compositions derived from coal tar, have tint, but do not have clear compositions. In some embodiments, the rejuvenating compositions disclosed herein are coated onto the pavement surface and penetrate below the surface. In some embodiments, the rejuvenating compositions disclosed herein are sprayed onto the pavement surface and penetrate below the surface. In some embodiments, the rejuvenating compositions disclosed herein are applied to the pavement surface and penetrate below the surface.

In some embodiments, the rejuvenating composition is clear. In some embodiments, the rejuvenating composition does not comprise a tinting agent. In some embodiments, the rejuvenating composition comprises a tinting agent. In some embodiments, the rejuvenating composition is customized based on color by adjusting the amount of tinting agent in the composition. In some embodiments, the tinting agent is present in an amount of about 1% to about 20% by weight of the asphalt rejuvenation composition. In some embodiments, the tinting agent is present in an amount of about 2% to about 10% by weight of the asphalt rejuvenation composition. In some embodiments, the acetic acid is present in an amount of about 3% to about 5% by weight of the asphalt rejuvenation composition. In some embodiments, the tinting agent is present in an amount of about 3% by weight of the asphalt rejuvenation composition. In some embodiments, the tinting agent is present in an amount of about 4% by weight of the asphalt rejuvenation composition. In some embodiments, the tinting agent is present in an amount of about 5% by weight of the asphalt rejuvenation composition.

In some embodiments, the rejuvenating agent comprises a tinting agent, and the water is present in an amount of about 35% to about 75% by weight of the asphalt rejuvenation composition. In some embodiments, the rejuvenating agent comprises a tinting agent, and the water is present in an amount of about 40% to about 65% by weight of the asphalt rejuvenation composition.

In some embodiments, the asphalt rejuvenation composition comprises:
about 45% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition; and
about 0.01% to about 1% of acetic acid by weight of the asphalt rejuvenation composition.

In some embodiments, the asphalt rejuvenation composition comprises:
about 45% to about 75% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition; and
about 0.01% to about 0.1% of acetic acid by weight of the asphalt rejuvenation composition.

In some embodiments, the asphalt rejuvenation composition comprises:
about 45% to about 75% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition; and
about 0.03% to about 0.06% of acetic acid by weight of the asphalt rejuvenation composition.

In some embodiments, the asphalt rejuvenation composition comprises:
about 60% of water by weight of the asphalt rejuvenation composition;
about 25% of a rejuvenating agent by weight of the asphalt rejuvenation composition;
about 9% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

In some embodiments, the asphalt rejuvenation composition comprises:
about 52% of water by weight of the asphalt rejuvenation composition;
about 30% of a rejuvenating agent by weight of the asphalt rejuvenation composition;
about 9% of a self-linking-cross polymer by weight of the asphalt rejuvenation composition;
about 8% of a first surfactant by weight of the asphalt rejuvenation composition;
about 0.6% of a second surfactant by weight of the asphalt rejuvenation composition;
about 0.6% of a de-foaming agent by weight of the asphalt rejuvenation composition; and
about 0.06% of acetic acid by weight of the asphalt rejuvenation composition.

In some embodiments, the asphalt rejuvenation composition comprises:
about 50% of water by weight of the asphalt rejuvenation composition;
about 32% of a rejuvenating agent by weight of the asphalt rejuvenation composition;
about 11% of a self-linking-cross polymer by weight of the asphalt rejuvenation composition;
about 6% of a first surfactant by weight of the asphalt rejuvenation composition;
about 0.5% of a second surfactant by weight of the asphalt rejuvenation composition;
about 0.5% of a de-foaming agent by weight of the asphalt rejuvenation composition; and
about 0.03% of acetic acid by weight of the asphalt rejuvenation composition.

In some embodiments, the asphalt rejuvenation composition comprises:
about 61% of water by weight of the asphalt rejuvenation composition;
about 24% of a rejuvenating agent by weight of the asphalt rejuvenation composition;
about 10% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

In some embodiments, the asphalt rejuvenation composition comprises:
about 35% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition;
about 0.01% to about 1% of acetic acid by weight of the asphalt rejuvenation composition; and
about 1% to about 20% of a tinting agent by weight of the asphalt rejuvenation composition.

In some embodiments, the asphalt rejuvenation composition comprises:
about 40% to about 65% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition;
about 0.01% to about 0.1% of acetic acid by weight of the asphalt rejuvenation composition; and
about 2% to about 10% of a tinting agent by weight of the asphalt rejuvenation composition.

In some embodiments, the asphalt rejuvenation composition comprises:
about 40% to about 65% of water by weight of the asphalt rejuvenation composition; about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition;
about 0.03% to about 0.06% of acetic acid by weight of the asphalt rejuvenation composition; and
about 3% to about 5% of a tinting agent by weight of the asphalt rejuvenation composition.

In some embodiments, the asphalt rejuvenation composition comprises:
about 46% of water by weight of the asphalt rejuvenation composition;
about 28% of a rejuvenating agent by weight of the asphalt rejuvenation composition;
about 15% of a self-linking-cross polymer by weight of the asphalt rejuvenation composition;
about 6% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition;
about 0.05% of acetic acid by weight of the asphalt rejuvenation composition; and
about 5% of a tinting agent by weight of the asphalt rejuvenation composition.

Some embodiments comprise a method of treating asphalt pavement comprising applying the asphalt rejuvenation composition to the surface of the pavement. In some embodiments, the ratio of rejuvenating agent to self-cross-linking polymer in the asphalt rejuvenation composition used to treat asphalt pavement is about 3:1. In some embodiments, the ratio of rejuvenating agent to self-cross-linking polymer in the asphalt rejuvenation composition used to treat asphalt pavement is about 2.5:1. In some embodiments, the ratio of rejuvenating agent to self-cross-linking polymer in the asphalt rejuvenation composition used to treat asphalt pavement is about 3:2. In some embodiments, the ratio of rejuvenating agent to self-cross-linking polymer in the asphalt rejuvenation composition used to treat asphalt pavement is about 2:1.

In some embodiments, the asphalt pavement is dense graded friction course pavement. In some embodiments, the asphalt pavement is open graded friction course pavement.

Some embodiments comprise a method of treating dense graded friction course pavement comprising applying the asphalt rejuvenation composition to the surface of the pavement. In some embodiments, the ratio of rejuvenating agent to self-cross-linking polymer in the asphalt rejuvenation composition used to treat dense graded friction course pavement is about 3:1. In some embodiments, the ratio of rejuvenating agent to self-cross-linking polymer in the asphalt rejuvenation composition used to treat dense graded friction course pavement is about 2.5:1. In some embodiments, the ratio of rejuvenating agent to self-cross-linking polymer in the asphalt rejuvenation composition used to treat dense graded friction course pavement is about 3:2. In some embodiments, the ratio of rejuvenating agent to self-cross-linking polymer in the asphalt rejuvenation composition used to treat asphalt pavement is about 2:1.

Some embodiments comprise a method of treating open graded friction course pavement comprising applying the asphalt rejuvenation composition to the surface of the pavement. In some embodiments, the ratio of rejuvenating agent to self-cross-linking polymer in the asphalt rejuvenation composition used to treat open graded friction course pavement is about 3:1. In some embodiments, the ratio of rejuvenating agent to self-cross-linking polymer in the asphalt rejuvenation composition used to treat open graded friction course pavement is about 2.5:1. In some embodiments, the ratio of rejuvenating agent to self-cross-linking polymer in the asphalt rejuvenation composition used to treat open graded friction course pavement is about 3:2. In some embodiments, the ratio of rejuvenating agent to self-cross-linking polymer in the asphalt rejuvenation composition used to treat asphalt pavement is about 2:1.

Some embodiments comprise a method of treating asphalt pavement comprising applying an asphalt rejuvenation composition to the surface of the pavement, wherein the asphalt rejuvenation composition comprises:
about 45% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition; and
about 0.01% to about 1% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 45% to about 75% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition; and
about 0.01% to about 0.1% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 45% to about 75% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition; and
about 0.03% to about 0.06% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 60% of water by weight of the asphalt rejuvenation composition;
about 25% of a rejuvenating agent by weight of the asphalt rejuvenation composition;
about 9% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 52% of water by weight of the asphalt rejuvenation composition;
about 30% of a rejuvenating agent by weight of the asphalt rejuvenation composition;
about 9% of a self-linking-cross polymer by weight of the asphalt rejuvenation composition;
about 8% of a first surfactant by weight of the asphalt rejuvenation composition;
about 0.6% of a second surfactant by weight of the asphalt rejuvenation composition;
about 0.6% of a de-foaming agent by weight of the asphalt rejuvenation composition; and
about 0.06% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 50% of water by weight of the asphalt rejuvenation composition;
about 32% of a rejuvenating agent by weight of the asphalt rejuvenation composition;
about 11% of a self-linking-cross polymer by weight of the asphalt rejuvenation composition;
about 6% of a first surfactant by weight of the asphalt rejuvenation composition;
about 0.5% of a second surfactant by weight of the asphalt rejuvenation composition;
about 0.5% of a de-foaming agent by weight of the asphalt rejuvenation composition; and
about 0.03% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 61% of water by weight of the asphalt rejuvenation composition;
about 24% of a rejuvenating agent by weight of the asphalt rejuvenation composition;
about 10% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 35% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition;
about 0.01% to about 1% of acetic acid by weight of the asphalt rejuvenation composition; and
about 1% to about 20% of a tinting agent by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 40% to about 65% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition;
about 0.01% to about 0.1% of acetic acid by weight of the asphalt rejuvenation composition; and
about 2% to about 10% of a tinting agent by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 40% to about 65% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition;
about 0.03% to about 0.06% of acetic acid by weight of the asphalt rejuvenation composition; and
about 3% to about 5% of a tinting agent by weight of the asphalt rejuvenation composition.

Some embodiments comprise a method of treating asphalt pavement comprising applying an asphalt rejuvenation composition to the surface of the pavement, wherein the asphalt rejuvenation composition comprises:
about 46% of water by weight of the asphalt rejuvenation composition;
about 28% of a rejuvenating agent by weight of the asphalt rejuvenation composition;
about 15% of a self-linking-cross polymer by weight of the asphalt rejuvenation composition;
about 6% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition;
about 0.05% of acetic acid by weight of the asphalt rejuvenation composition; and
about 5% of a tinting agent by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 45% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition; and
about 0.01% to about 1% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 45% to about 75% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition; and
about 0.01% to about 0.1% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 45% to about 75% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition; and
about 0.03% to about 0.06% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 60% of water by weight of the asphalt rejuvenation composition;
about 25% of a rejuvenating agent by weight of the asphalt rejuvenation composition;
about 9% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 52% of water by weight of the asphalt rejuvenation composition;
about 30% of a rejuvenating agent by weight of the asphalt rejuvenation composition;
about 9% of a self-linking-cross polymer by weight of the asphalt rejuvenation composition;
about 8% of a first surfactant by weight of the asphalt rejuvenation composition;
about 0.6% of a second surfactant by weight of the asphalt rejuvenation composition;
about 0.6% of a de-foaming agent by weight of the asphalt rejuvenation composition; and
about 0.06% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 50% of water by weight of the asphalt rejuvenation composition;
about 32% of a rejuvenating agent by weight of the asphalt rejuvenation composition;
about 11% of a self-linking-cross polymer by weight of the asphalt rejuvenation composition;
about 6% of a first surfactant by weight of the asphalt rejuvenation composition;
about 0.5% of a second surfactant by weight of the asphalt rejuvenation composition;
about 0.5% of a de-foaming agent by weight of the asphalt rejuvenation composition; and
about 0.03% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 61% of water by weight of the asphalt rejuvenation composition;
about 24% of a rejuvenating agent by weight of the asphalt rejuvenation composition;
about 10% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 35% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition;
about 0.01% to about 1% of acetic acid by weight of the asphalt rejuvenation composition; and
about 1% to about 20% of a tinting agent by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 40% to about 65% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition;
about 0.01% to about 0.1% of acetic acid by weight of the asphalt rejuvenation composition; and
about 2% to about 10% of a tinting agent by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 40% to about 65% of water by weight of the asphalt rejuvenation composition; about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition;
about 0.03% to about 0.06% of acetic acid by weight of the asphalt rejuvenation composition; and
about 3% to about 5% of a tinting agent by weight of the asphalt rejuvenation composition.

Some embodiments comprise a method of treating open graded friction course pavement comprising applying an asphalt rejuvenation composition to the surface of the pavement, wherein the asphalt rejuvenation composition comprises:
about 46% of water by weight of the asphalt rejuvenation composition;
about 28% of a rejuvenating agent by weight of the asphalt rejuvenation composition;
about 15% of a self-linking-cross polymer by weight of the asphalt rejuvenation composition;
about 6% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition;
about 0.05% of acetic acid by weight of the asphalt rejuvenation composition; and
about 5% of a tinting agent by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 45% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition; and
about 0.01% to about 1% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 45% to about 75% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition; and
about 0.01% to about 0.1% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 45% to about 75% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition; and
about 0.03% to about 0.06% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 60% of water by weight of the asphalt rejuvenation composition;
about 25% of a rejuvenating agent by weight of the asphalt rejuvenation composition;
about 9% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 52% of water by weight of the asphalt rejuvenation composition;
about 30% of a rejuvenating agent by weight of the asphalt rejuvenation composition;
about 9% of a self-linking-cross polymer by weight of the asphalt rejuvenation composition;
about 8% of a first surfactant by weight of the asphalt rejuvenation composition;
about 0.6% of a second surfactant by weight of the asphalt rejuvenation composition;
about 0.6% of a de-foaming agent by weight of the asphalt rejuvenation composition; and
about 0.06% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 50% of water by weight of the asphalt rejuvenation composition;
about 32% of a rejuvenating agent by weight of the asphalt rejuvenation composition;
about 11% of a self-linking-cross polymer by weight of the asphalt rejuvenation composition;
about 6% of a first surfactant by weight of the asphalt rejuvenation composition;
about 0.5% of a second surfactant by weight of the asphalt rejuvenation composition;
about 0.5% of a de-foaming agent by weight of the asphalt rejuvenation composition; and
about 0.03% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 61% of water by weight of the asphalt rejuvenation composition;
about 24% of a rejuvenating agent by weight of the asphalt rejuvenation composition;
about 10% of a self-linking-cross polymer by weight of the asphalt rejuvenation composition;
about 5% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition; and
about 0.04% of acetic acid by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 35% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition;
about 0.01% to about 1% of acetic acid by weight of the asphalt rejuvenation composition; and
about 1% to about 20% of a tinting agent by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 40% to about 65% of water by weight of the asphalt rejuvenation composition;
about 20% to about 40% of a rejuvenating agent by weight of the asphalt rejuvenation composition;
about 5% to about 25% of a self-linking-cross polymer by weight of the asphalt rejuvenation composition;
about 3% to about 8.5% of a first surfactant by weight of the asphalt rejuvenation composition;
about 0.1% to about 1% of a second surfactant by weight of the asphalt rejuvenation composition;
about 0.1% to about 1% of a de-foaming agent by weight of the asphalt rejuvenation composition;
about 0.01% to about 0.1% of acetic acid by weight of the asphalt rejuvenation composition; and
about 2% to about 10% of a tinting agent by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 40% to about 65% of water by weight of the asphalt rejuvenation composition;
about 23% to about 35% of a rejuvenating agent by weight of the asphalt rejuvenation composition;
about 8% to about 20% of a self-linking-cross polymer by weight of the asphalt rejuvenation composition;
about 4% to about 7% of a first surfactant by weight of the asphalt rejuvenation composition;
about 0.1% to about 0.5% of a second surfactant by weight of the asphalt rejuvenation composition;
about 0.1% to about 0.5% of a de-foaming agent by weight of the asphalt rejuvenation composition;
about 0.03% to about 0.06% of acetic acid by weight of the asphalt rejuvenation composition; and
about 3% to about 5% of a tinting agent by weight of the asphalt rejuvenation composition.

Some embodiments comprise a method of treating dense graded friction course pavement comprising applying an asphalt rejuvenation composition to the surface of the pavement, wherein the asphalt rejuvenation composition comprises:
about 46% of water by weight of the asphalt rejuvenation composition;
about 28% of a rejuvenating agent by weight of the asphalt rejuvenation composition;
about 15% of a self-linking-cross polymer by weight of the asphalt rejuvenation composition;
about 6% of a first surfactant by weight of the asphalt rejuvenation composition;
about 0.4% of a second surfactant by weight of the asphalt rejuvenation composition;
about 0.4% of a de-foaming agent by weight of the asphalt rejuvenation composition;
about 0.05% of acetic acid by weight of the asphalt rejuvenation composition; and
about 5% of a tinting agent by weight of the asphalt rejuvenation composition.

In some embodiments, the rejuvenating agent is a tall oil-derived fatty ester, the self-linking-cross polymer is in an acrylic polymer emulsion comprising the self-linking-cross polymer, an emulsion surfactant, and water, wherein the self-linking-cross polymer comprises a combination of methylmethacrylate monomer and butyl acrylate monomer;
the first surfactant is a non-ionic nonylphenol ethoxylate;
the second surfactant is a tetramethyldecynediol in ethylene glycol;
the de-foaming agent is a mixture of hydrophobic solids and foam destroying polysiloxanes in polyglycol.

In some embodiments, the rejuvenating agent is a tall oil-derived fatty ester, wherein the tall oil-derived fatty ester has a cyclic content of at least 5 wt. %;
the self-linking-cross polymer is in an acrylic polymer emulsion comprising the self-linking-cross, an emulsion surfactant and water, wherein the self-linking-cross comprises a combination of about 35 wt. % to about 85 wt. % of methylmethacrylate monomer and about 30 wt. % to about 80 wt. % of butyl acrylate monomer, and wherein the emulsion surfactant comprises about 0.1 wt. % to about 5 wt. % of alkyl ethyloxylates;
the first surfactant is a non-ionic nonylphenol ethoxylate;
the second surfactant is a tetramethyldecynediol in ethylene glycol;
the de-foaming agent is a mixture of hydrophobic solids and foam destroying polysiloxanes in polyglycol.

In one preferred embodiment, the rejuvenating agent is Sylvaroad™ RP-1000;
the acrylic polymer emulsion comprising the self-linking-cross polymer is Ottopol K12T;
the first surfactant is Brosurf NP-6;
the second surfactant is Surfynol 104H;
the de-foaming agent is BYK 022.

In some embodiments, the tinting agent is carbon black. In some embodiments, the tinting agent is Novocolor IP. In some embodiments, the tinting agent is Novocolor IP 8594 500. Novocolor IP tinting agents are commercially available, e.g., from Engineered Polymer Solutions and Color Corporation of America, Chicago, IL).

In some embodiments, the pavement rejuvenating compositions disclosed herein are mixed with RAP and the admixture re-applied to the road surface.

The pavement rejuvenation compositions disclosed herein are made by sequential addition of the constituents to a mixing vessel. Where applicable, each constituent should be agitated to ensure homogeneity and heated if necessary prior to the manufacturing process. The vessel used to make the rejuvenation compositions is thoroughly cleaned and should be free from any potential contaminants. The raw material order of addition is given below in Table 1 for an exemplary formulation (Composition 1).

TABLE 1

| Name | Density (lbs./gal.) |
|---|---|
| Water | 8.33 |
| BYK 022 (440#) | 8.3 |
| Brosurf NP-6 (460#) | 8.67 |
| Surfynol 104H (425 #) | 7.91 |
| Rejuvenating Agent | 7.72 |
| Acetic Acid 28% (55 gal) | 8.45 |
| Cationic Resin | 8.83 |
| Ethylene Glycol (515 #) | 9.31 |
| Water | 8.33 |

Table 2 below discloses the constituents in one exemplary formulation (Composition 1) and the weight percentage in which each constituent is present to provide an asphalt rejuvenation formulation as described herein.

TABLE 2
Formula

| Name | Density (lbs./gal.) | % by wt. |
|---|---|---|
| Water | 8.33 | 30.58% |
| BYK 022 (440#) | 8.3 | 0.46% |
| Brosurf NP6 (460#) | 8.67 | 6.12% |
| Surfynol 104H (425#) | 7.91 | 0.46% |
| Rejuvenating Agent | 7.72 | 30.58% |
| Acetic Acid 28% (55 gal) | 8.45 | 0.18% |
| Cationic Resin | 8.83 | 30.58% |
| Ethylene Glycol (515 #) | 9.31 | 1.06% |
| | | 100.0% |

Table 3 below discloses the weight percent range of each constituent of an exemplary pavement rejuvenation formulation (Composition 1) described herein.

TABLE 3

| Formula | | | |
|---|---|---|---|
| | Density | | Range |
| Name | (lbs./gal.) | % by wt. | % by wt. |
| Water | 8.33 | 30.58% | 20.0-70.0 |
| BYK 022 (440#) | 8.3 | 0.46% | 0.1-1.0 |
| Brosurf NP6 (460#) | 8.67 | 6.12% | 2.0-10.0 |
| Surfynol 104H (425#) | 7.91 | 0.46% | 0.1-1.0 |
| Rejuvenating agent | 7.72 | 30.58% | 5.0-70.0 |
| Acetic Acid 28% (55 gal) | 8.45 | 0.18% | 0.01-1.0 |
| Cationic Resin | 8.83 | 30.58% | 5.0-50.0 |
| Ethylene Glycol (515 #) | 9.31 | 1.06% | 0.1-5.0 |
| | | 100.00% | |

Table 4 below discloses the constituents in one exemplary formulation (Composition 2) and the weight percentage in which each constituent is present to provide an asphalt rejuvenation formulation as described herein.

TABLE 4
Composition 2

| | Density | | | % by | Actual |
|---|---|---|---|---|---|
| Name | (lbs./gal.) | lbs. | Gals. | wt. | Weight % |
| Water^{a} | 8.33 | 504.80 | 60.60 | 47.89% | 59.90% |
| BYK 022 (440#) | 8.3 | 3.90 | 0.47 | 0.37% | 0.37% |
| Brosurf NP-6 (460#) | 8.67 | 52.00 | 6.00 | 4.93% | 4.93% |
| Surfynol 104H | 7.91 | 3.90 | 0.49 | 0.37% | 0.37% |
| (425 #) | | | | | |
| Sylvaroad ™ | 7.72 | 268.00 | 34.72 | 25.42% | 25.42% |
| RP-1000 (2100#) | | | | | |
| Acetic Acid 28% | 8.45 | 1.50 | 0.18 | 0.14% | 0.039% |
| (55 gal)^{b} | | | | | |

MIX ABOVE UNDER HIGH SHEER 40 minutes

| | | | | | |
|---|---|---|---|---|---|
| Ottopol K-12T | 8.83 | 220.00 | 24.92 | 20.87% | 8.97% |
| (2200 #)^{c} | | | | | |
| | | 1054.10 | 127.37 | 100.00% | 100.00% |

^{a}The “lbs.”, “Gals.” and “% by wt.” indicates the amount of water added to the composition, but not the water derived from the acetic acid solution or the Ottopol polymer emulsion. The “actual weight %” of water includes the water present in the acetic acid solution (72% water) and the Ottopol polymer emulsion (57% water).
^{b}The “lbs.”, “Gals.” and “% by wt.” indicates the amount of 28% acetic acid added to the composition. The “actual weight % for acetic acid is only the actual acetic acid (28%) and does not include the water present in the 28% acetic acid solution.
^{c}The “lbs.”, “Gals.” and “% by wt.” indicates the amount of Ottopol polymer emulsion added to the composition. The “actual weight % for Ottopol is for the weight solids portion of the polymer emulsion (43%) and does not include the water present in the polymer emulsion.

Table 5 below discloses the constituents in one exemplary formulation (Composition 3) and the weight percentage in which each constituent is present to provide an asphalt rejuvenation formulation as described herein.

TABLE 5
Composition 3

| | Density | | | % by | Actual |
|---|---|---|---|---|---|
| Name | (lbs./gal.) | lbs. | Gals. | wt. | Weight % |
| Water^{a} | 8.33 | 228.00 | 27.37 | 25.19% | 45.78% |
| BYK 022 (440#) | 8.3 | 3.80 | 0.46 | 0.42% | 0.42% |
| Brosurf NP-6 (460#) | 8.67 | 51.00 | 5.88 | 5.63% | 5.63% |
| Surfynol 104H | 7.91 | 3.80 | 0.48 | 0.42% | 0.42% |
| (425 #) | | | | | |
| Sylvaroad ™ RP- | 7.72 | 250.00 | 32.38 | 27.62% | 27.62% |
| 1000 (2100#) | | | | | |
| TINT-Novocolor IP | 10.16 | 42.00 | 4.13 | 4.64% | 4.64% |
| 8594 500# | | | | | |
| Acetic Acid 28% | 8.45 | 1.50 | 0.18 | 0.17% | 0.048% |
| (55 gal)^{b} | | | | | |

MIX ABOVE UNDER HIGH SHEER 40 minutes

| | | | | | |
|---|---|---|---|---|---|
| Ottopol K-12T | 8.83 | 325.00 | 36.81 | 35.91% | 15.44% |
| (2200 #)^{c} | | 905.10 | 107.69 | 100.00% | 100.00 |

^{a}The “lbs.”, “Gals.” and “% by wt.” indicates the amount of water added to the composition, but not the water derived from the acetic acid solution or the Ottopol polymer emulsion. The “actual weight %” of water includes the water present in the acetic acid solution (72% water) and the Ottopol polymer emulsion (57% water).
^{b}The “lbs.”, “Gals.” and “% by wt.” indicates the amount of 28% acetic acid added to the composition. The “actual weight % for acetic acid is only the actual acetic acid (28%) and does not include the water present in the 28% acetic acid solution.
^{c}The “lbs.”, “Gals.” and “% by wt.” indicates the amount of Ottopol polymer emulsion added to the composition. The “actual weight % for Ottopol is for the weight solids portion of the polymer emulsion (43%) and does not include the water present in the polymer emulsion.

Table 6 below discloses the constituents in one exemplary formulation (Composition 4) and the weight percentage in which each constituent is present to provide an asphalt rejuvenation formulation as described herein.

TABLE 6
Composition 4

| | Density | | | | Actual |
|---|---|---|---|---|---|
| Name | (lbs./gal.) | lbs. | Gals. | % by wt. | Weight % |
| Water^{a} | 8.33 | 260.00 | 31.21 | 39.62% | 51.52% |
| BYK 022 (440#) | 8.3 | 3.90 | 0.47 | 0.59% | 0.59% |
| Brosurf NP-6 | 8.67 | 52.00 | 6.00 | 7.92% | 7.92% |
| (460#) | | | | | |
| Surfynol 104H | 7.91 | 3.90 | 0.49 | 0.59% | 0.59% |
| (425 #) | | | | | |
| Sylvaroad ™ RP- | 7.72 | 200.00 | 25.91 | 30.47% | 30.47% |
| 1000 (2100#) | | | | | |
| Acetic Acid 28% | 8.45 | 1.50 | 0.18 | 0.23% | 0.064% |
| (55 gal)^{b} | | | | | |

MIX ABOVE UNDER HIGH SHEER 40 minutes

| | | | | | |
|---|---|---|---|---|---|
| Ottopol K-12T | 8.83 | 135.00 | 15.29 | 20.57% | 8.85% |
| (2200 #)^{c} | | 656.30 | 79.55 | 100.00% | 100.00% |

^{a}The “lbs.”, “Gals.” and “% by wt.” indicates the amount of water added to the composition, but not the water derived from the acetic acid solution or the Ottopol polymer emulsion. The “actual weight %” of water includes the water present in the acetic acid solution (72% water) and the Ottopol polymer emulsion (57% water).
^{b}The “lbs.”, “Gals.” and “% by wt.” indicates the amount of 28% acetic acid added to the composition. The “actual weight % for acetic acid is only the actual acetic acid (28%) and does not include the water present in the 28% acetic acid solution.
^{c}The “lbs.”, “Gals.” and “% by wt.” indicates the amount of Ottopol polymer emulsion added to the composition. The “actual weight % for Ottopol is for the weight solids portion of the polymer emulsion (43%) and does not include the water present in the polymer emulsion.

Table 7 below discloses the constituents in one exemplary formulation (Composition 5) and the weight percentage in which each constituent is present to provide an asphalt rejuvenation formulation as described herein.

TABLE 7
Composition 5

| | Density | | | | Actual |
|---|---|---|---|---|---|
| Name | (lbs./gal.) | lbs. | Gals. | % by wt. | Weight % |
| Water^{a} | 8.33 | 293.98 | 35.29 | 34.86% | 49.81% |
| BYK 022 (440#) | 8.3 | 3.90 | 0.47 | 0.46% | 0.46% |
| Brosurf NP-6 (460#) | 8.67 | 52.00 | 6.00 | 6.17% | 6.17% |
| Surfynol 104H | 7.91 | 3.90 | 0.49 | 0.46% | 0.46% |
| (425 #) | | | | | |
| Sylvaroad ™ RP- | 7.72 | 268.00 | 34.72 | 31.78% | 31.78% |
| 1000 (2100#) | | | | | |
| Acetic Acid 28% | 8.45 | 1.50 | 0.18 | 0.12% | 0.034% |
| (55 gal)^{b} | | | | | |

MIX ABOVE UNDER HIGH SHEER 40 minutes

| | | | | | |
|---|---|---|---|---|---|
| Ottopol K-12T | 8.83 | 220.00 | 24.92 | 26.08% | 11.21% |
| (2200 #)^{c} | | | | | |
| | | 843.28 | 102.07 | 100% | 100.00% |

^{a}The “lbs.”, “Gals.” and “% by wt.” indicates the amount of water added to the composition, but not the water derived from the acetic acid solution or the Ottopol polymer emulsion. The “actual weight %” of water includes the water present in the acetic acid solution (72% water) and the Ottopol polymer emulsion (57% water).
^{b}The “lbs.”, “Gals.” and “% by wt.” indicates the amount of 28% acetic acid added to the composition. The “actual weight % for acetic acid is only the actual acetic acid (28%) and does not include the water present in the 28% acetic acid solution.
^{c}The “lbs.”, “Gals.” and “% by wt.” indicates the amount of Ottopol polymer emulsion added to the composition. The “actual weight % for Ottopol is for the weight solids portion of the polymer emulsion (43%) and does not include the water present in the polymer emulsion.

Table 8 below discloses the constituents in one exemplary formulation (Composition 6) and the weight percentage in which each constituent is present to provide an asphalt rejuvenation formulation as described herein.

TABLE 8
Composition 6

| | Density | | | % by | Actual |
|---|---|---|---|---|---|
| Name | (lbs./gal.) | lbs. | Gals. | wt. | Weight % |
| Water^{a} | 8.33 | 513.57 | 61.65 | 46.91% | 60.59% |
| BYK 022 (440#) | 8.3 | 3.90 | 0.47 | 0.36% | 0.36% |
| Brosurf NP-6 | 8.67 | 52.00 | 6.00 | 4.75% | 4.75% |
| (460#) | | | | | |
| Surfynol 104H | 7.91 | 3.90 | 0.49 | 0.36% | 0.36% |
| (425 #) | | | | | |
| Sylvaroad ™ RP- | 7.72 | 260.00 | 33.68 | 23.75% | 23.8% |
| 1000 (2100#) | | | | | |
| Acetic Acid 28% | 8.45 | 1.50 | 0.18 | 0.14% | 0.039% |
| (55 gal)^{b} | | | | | |

MIX ABOVE UNDER HIGH SHEER 40 minutes

| | | | | | |
|---|---|---|---|---|---|
| Ottopol K-12T | 8.83 | 260.00 | 29.45 | 23.75% | 10.21% |
| (2200 #)^{c} | | | | | |
| | | 1094.87 | 131.92 | 100.00% | 100.00% |

^{a}The “lbs.”, “Gals.” and “% by wt.” indicates the amount of water added to the composition, but not the water derived from the acetic acid solution or the Ottopol polymer emulsion. The “actual weight %” of water includes the water present in the acetic acid solution (72% water) and the Ottopol polymer emulsion (57% water).
^{b}The “lbs.”, “Gals.” and “% by wt.” indicates the amount of 28% acetic acid added to the composition. The “actual weight % for acetic acid is only the actual acetic acid (28%) and does not include the water present in the 28% acetic acid solution.
^{c}The “lbs.”, “Gals.” and “% by wt.” indicates the amount of Ottopol polymer emulsion added to the composition. The “actual weight % for Ottopol is for the weight solids portion of the polymer emulsion (43%) and does not include the water present in the polymer emulsion.

In one exemplary embodiment, a rejuvenation composition is prepared by combining the rejuvenator (e.g., Sylvaroad RP-1000™), with water, a self-cross-linking polymer in a polymer emulsion, a de-foaming agent and one or more surfactants as described herein. These constituents are mixed in a high shear mixer for about 40 minutes to form a pre-dispersion phase. The pH of the pre-dispersion phase is preferably adjusted to be between pH 4.5 and 5.5. The pre-dispersion is fully homogenous with no signs of phase separation.

Thereafter, the pre-dispersion phase is blended together with the self-cross-linking polymer in the polymer emulsion, a solvent and water to create the final rejuvenation composition. The final blended product is tested again for pH (preferably in the range between pH 4.0 and 6.0, and preferably between 4.5-5.0) and residual solids content and treated to contain less than 1% particulate content when passed through a 250 micron sieve.

In some embodiments is method of treating asphalt pavement, which comprises applying an asphalt rejuvenation composition described herein to the surface of the asphalt pavement. The preferred method for applying the rejuvenating compositions disclosed herein is by spraying the composition onto the pavement surface.

The distributor for spreading the asphalt rejuvenating composition can be a conventional self-propelled spraying device that includes full circulation spray bars, a pump tachometer, volume measuring device and a hand hose attachment suitable for application of the composition manually to cover areas inaccessible to the distributor. The distributor is designed and equipped to distribute the asphalt rejuvenating polymer sealer uniformly on variable widths of pavement surface at readily determined and controlled rates from 0.01 to 0.07 gallons per square yard of surface. The rate of application is controlled by an onboard computer control system designed to uniformly and consistently control the selected application rate in gallons per square yard.

In some embodiments, the asphalt rejuvenation composition is applied at a rate of between about 0.01 and about 0.07 gallons per square yard. In some embodiments, the asphalt rejuvenation composition is applied at a rate of between about 0.015 and about 0.03 gallons per square yard. In some embodiments, the asphalt rejuvenation composition is applied at a rate of about 0.02 gallons per square yard. In some embodiments, the asphalt rejuvenation composition is applied at a rate of about 0.03 gallons per square yard. In some embodiments, the asphalt rejuvenation composition is applied at a rate of about 0.04 gallons per square yard. In some embodiments, the asphalt rejuvenation composition is applied at a rate of about 0.05 gallons per square yard. In some embodiments, the asphalt rejuvenation composition is applied at a rate of about 0.06 gallons per square yard. In some embodiments, the method comprises spraying the asphalt composition onto the surface of the asphalt pavement, wherein the asphalt pavement is an asphalt road. In some embodiments, the asphalt pavement is dense-graded friction course pavement. In some embodiments, the asphalt pavement is open-graded friction course pavement. In some embodiments, the asphalt rejuvenation composition is applied with an asphalt sealer spray machine. In some embodiments, the asphalt rejuvenation composition is applied as a single layer to the asphalt pavement. In some embodiments, the asphalt rejuvenation composition dries in about one hour to about two hours on the asphalt pavement without the need for sanding. In some embodiments, the complex modulus and the complex viscosity of the asphalt pavement are reduced by at least 40% at three months post-treatment with the asphalt rejuvenation composition.

The following examples further illustrate use of the rejuvenating compositions disclosed herein.

### Example 1

Two sections of asphalt pavement were treated with the exemplary rejuvenating composition disclosed above in Table 1. The composition was applied using an asphalt sealer spray machine that includes adjustable nozzles and apparatus that can adjust the application rate of the asphalt rejuvenating composition. The road surface application machine was calibrated for an application rate of 0.024-0.025 gallons per Square Yard. The rejuvenation composition was applied over (1) An 8-9 year old Nova Chip® roadway and (2) a 6/7 year old Type 6 Hot Mix Asphalt (HMA) roadway. Hot mix asphalt is a mixture of aggregate like gravel and sand and asphalt cement that requires heating before installation. Nova Chip®/Ultra-Thin Bonded Wearing Course is used to help extend the life of a road. This ultra-thin bonded wearing course is an open graded hot mix asphalt placed over polymer modified asphalt emulsion through a special, self-priming paver.

Control cores and post-treated cores were collected and held for 24 hours in a bed of sand in an oven at 85° C. to simulate a 2-3 year aging cycle.

### Example 2

Two sections of pavement were coated with the rejuvenating composition in Table 1 above.

The rejuvenation apparatus was calibrated for an application rate of 0.023-0.024 gallons per Sq. Yard. The rejuvenating composition was applied to (1) A 3 year old Type 6 top and (2) to a 6/7 year old Type 6 HMA road. Control cores and post-treatment cores were pulled and analyzed.

The spray on rejuvenating compositions disclosed herein can be applied every 3-5 years to prolong pavements life by reducing the stiffness of the asphalt binder in the upper ⅜″ of a pavement. The rejuvenating compositions integrate into the upper ⅜″ of a pavement and act to restore the properties of aged binder, seal low-severity cracks, and make it possible to open the pavement to the traveling public with minimal interruption from placement.

### Example 3

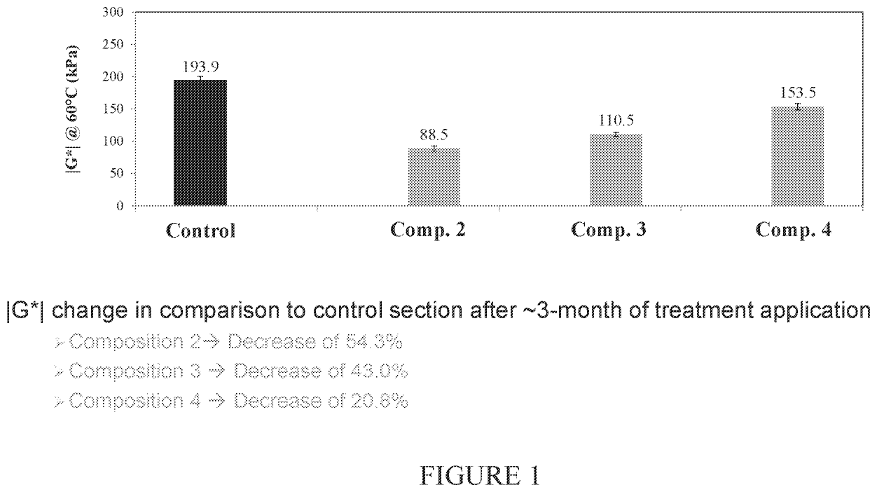

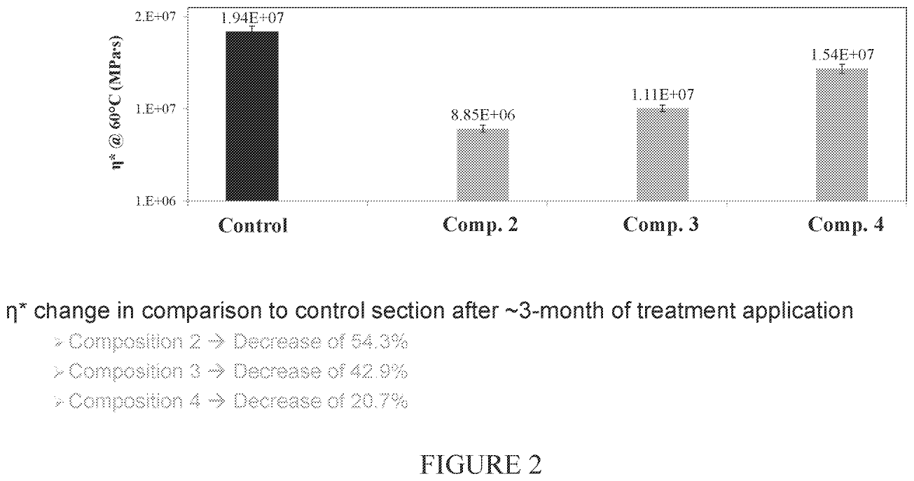

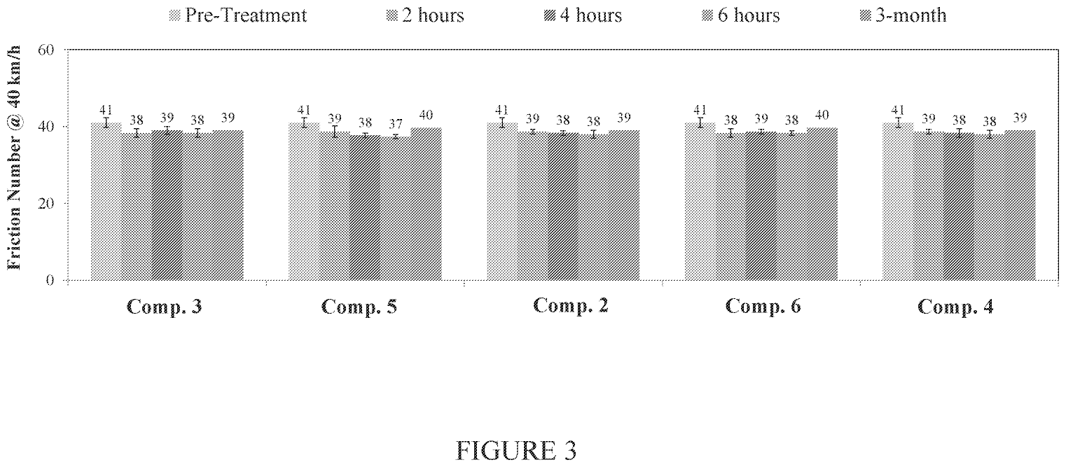

A rejuvenating composition (Composition 2, Table 4) was sprayed onto the road surface of US 280 (7-year OGFC) at a rate of about 0.02 gallons per square yard. After about 3 months, the complex modulus was measured at 60° C. and 10 rad/s via dynamic shear rheometer, and the results are summarized in FIG. 1. The G* value decreased 54.3% compared to non-treated pavement, indicating improved viscoelasticity of the asphalt. After about 3 months, the complex viscosity was measured at 60° C. via dynamic shear rheometer, and the results are summarized in FIG. 2. The η* value decreased 54.3% compared to non-treated pavement, indicating increased asphalt binder flexibility. In addition, the friction of the treated pavement was tested via Dynamic Friction Tester at time points of 2 hours, 4 hours, 6 hours, and 3 months after treatment, and the results are summarized in FIG. 3. At 2 hours post-treatment, the friction numbers at 40 km/h were close to the pre-treatment friction number of the pavement, indicating that the rejuvenating composition was sufficiently dried, and that the road could be opened to traffic. The friction numbers also remained close to the pre-treatment friction number after 4 hours, 6 hours, and 3 months.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 4

A rejuvenating composition (Composition 3, Table 5) was sprayed onto the road surface of US 280 (7-year OGFC) at a rate of about 0.02 gallons per square yard. After about 3 months, the complex modulus was measured at 60° C. and 10 rad/s via dynamic shear rheometer, and the results are summarized in FIG. 1. The G* value decreased 43.0% compared to non-treated pavement, indicating improved viscoelasticity of the asphalt. After about 3 months, the complex viscosity was measured at 60° C. via dynamic shear rheometer, and the results are summarized in FIG. 2. The η* value decreased 42.9% compared to non-treated pavement, indicating increased asphalt binder flexibility. In addition, the friction of the treated pavement was tested via Dynamic Friction Tester at time points of 2 hours, 4 hours, 6 hours, and 3 months after treatment, and the results are summarized in FIG. 3. At 2 hours post-treatment, the friction numbers at 40 km/h were close to the pre-treatment friction number of the pavement, indicating that the rejuvenating composition was sufficiently dried, and that the road could be opened to traffic. The friction numbers also remained close to the pre-treatment friction number after 4 hours, 6 hours, and 3 months.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 5

A rejuvenating composition (Composition 4, Table 6) was sprayed onto the road surface of US 280 (7-year OGFC) at a rate of about 0.02 gallons per square yard. After about 3 months, the complex modulus was measured at 60° C. and 10 rad/s via dynamic shear rheometer, and the results are summarized in FIG. 1. The G* value decreased 20.8% compared to non-treated pavement, indicating improved viscoelasticity of the asphalt. After about 3 months, the complex viscosity was measured at 60° C. via dynamic shear rheometer, and the results are summarized in FIG. 2. The η* value decreased 20.7% compared to non-treated pavement, indicating increased asphalt binder flexibility. In addition, the friction of the treated pavement was tested via Dynamic Friction Tester at time points of 2 hours, 4 hours, 6 hours, and 3 months after treatment, and the results are summarized in FIG. 3. At 2 hours post-treatment, the friction numbers at 40 km/h were close to the pre-treatment friction number of the pavement, indicating that the rejuvenating composition was sufficiently dried, and that the road could be opened to traffic. The friction numbers also remained close to the pre-treatment friction number after 4 hours, 6 hours, and 3 months.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 6

A rejuvenating composition (Composition 5, Table 7) was sprayed onto the road surface of US 280 (7-year OGFC) at a rate of about 0.02 gallons per square yard. The friction of the treated pavement was tested via Dynamic Friction Tester at time points of 2 hours, 4 hours, 6 hours, and 3 months after treatment, and the results are summarized in FIG. 3. At 2 hours post-treatment, the friction numbers at 40 km/h were close to the pre-treatment friction number of the pavement, indicating that the rejuvenating composition was sufficiently dried, and that the road could be opened to traffic. The friction numbers also remained close to the pre-treatment friction number after 4 hours, 6 hours, and 3 months.

Other parameters to be determined include complex modulus and complex viscosity.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 7

A rejuvenating composition (Composition 6, Table 8) was sprayed onto the road surface of US 280 (7-year OGFC) at a rate of about 0.02 gallons per square yard. The friction of the treated pavement was tested via Dynamic Friction Tester at time points of 2 hours, 4 hours, 6 hours, and 3 months after treatment, and the results are summarized in FIG. 3. At 2 hours post-treatment, the friction numbers at 40 km/h were close to the pre-treatment friction number of the pavement, indicating that the rejuvenating composition was sufficiently dried, and that the road could be opened to traffic. The friction numbers also remained close to the pre-treatment friction number after 4 hours, 6 hours, and 3 months.

Other parameters to be determined include complex modulus and complex viscosity at e.g., 60° C.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 8

A rejuvenating composition (Composition 2, Table 4) will be sprayed onto the surface of a dense graded friction course pavement. After about 3 months, the complex modulus (G* value) and complex viscosity (η* value) will be measured via dynamic shear rheometer, at e.g., 60° C., and compared with non-treated pavement. These results will indicate the rejuvenation of the pavement. In addition, the friction of the treated pavement will be tested via Dynamic Friction Tester at time points of 2 hours, 4 hours, 6 hours, and 3 months after treatment, and compared with the pre-treatment friction of the pavement. These numbers will indicate the predicted timing of road drying and re-opening of the road to traffic.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 9

A rejuvenating composition (Composition 3, Table 5) will be sprayed onto the surface of a dense graded friction course pavement. After about 3 months, the complex modulus (G* value) and complex viscosity (η* value) will be measured via dynamic shear rheometer, at e.g., 60° C., and compared with non-treated pavement. These results will indicate the rejuvenation of the pavement. In addition, the friction of the treated pavement will be tested via Dynamic Friction Tester at time points of 2 hours, 4 hours, 6 hours, and 3 months after treatment, and compared with the pre-treatment friction of the pavement. These numbers will indicate the predicted timing of road drying and re-opening of the road to traffic.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 10

A rejuvenating composition (Composition 4, Table 6) will be sprayed onto the surface of a dense graded friction course pavement. After about 3 months, the complex modulus (G* value) and complex viscosity (η* value) will be measured via dynamic shear rheometer, at e.g., 60° C., and compared with non-treated pavement. These results will indicate the rejuvenation of the pavement. In addition, the friction of the treated pavement will be tested via Dynamic Friction Tester at time points of 2 hours, 4 hours, 6 hours, and 3 months after treatment, and compared with the pre-treatment friction of the pavement. These numbers will indicate the predicted timing of road drying and re-opening of the road to traffic.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 11

A rejuvenating composition (Composition 5, Table 7) will be sprayed onto the surface of a dense graded friction course pavement. After about 3 months, the complex modulus (G* value) and complex viscosity (η* value) will be measured via dynamic shear rheometer, at e.g., 60° C., and compared with non-treated pavement. These results will indicate the rejuvenation of the pavement. In addition, the friction of the treated pavement will be tested via Dynamic Friction Tester at time points of 2 hours, 4 hours, 6 hours, and 3 months after treatment, and compared with the pre-treatment friction of the pavement. These numbers will indicate the predicted timing of road drying and re-opening of the road to traffic.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### Example 12

A rejuvenating composition (Composition 6, Table 8) will be sprayed onto the road surface of US 280 (7-year OGFC). After about 3 months, the complex modulus (G* value) and complex viscosity (η* value) will be measured via dynamic shear rheometer, at e.g., 60° C., and compared with non-treated pavement. These results will indicate the rejuvenation of the pavement. In addition, the friction of the treated pavement will be tested via Dynamic Friction Tester at time points of 2 hours, 4 hours, 6 hours, and 3 months after treatment, and compared with the pre-treatment friction of the pavement. These numbers will indicate the predicted timing of road drying and re-opening of the road to traffic.

Performance grading at various temperatures, i.e., about 95° C. will be assessed via dynamic shear rheometer. Performance grading at low temperatures and delta T_{c} will be assessed via bending beam rheometer. Rotational viscosity at high temperatures, i.e., about 135° C. will also be assessed. Phase angle at high temperatures, i.e., about 65° C. will also be assessed via dynamic shear rheometer. A frequency sweep will also be performed via dynamic shear rheometer.

Further testing on the long term effects of the rejuvenating composition on the pavement will take place via actual field aging of treated pavement, i.e., about 7 years and through testing of treated pavement that has been subjected to accelerated aging, i.e., via excess heat.

### ADDITIONAL/SUPPORTIVE EMBODIMENTS

1. In one embodiment is an asphalt coating composition comprising a rejuvenating agent, a self-cross-linking polymer, water and a surfactant.

2. The asphalt coating composition of embodiment 1, wherein the rejuvenating agent is a tall oil derivative.

3. The asphalt coating composition of embodiment 2, wherein the rejuvenating agent is a tall oil fatty acid.

4. The asphalt coating composition of embodiment 1, wherein the rejuvenating agent is free of aromatic solvents.

5. The asphalt coating composition of embodiment 1, wherein the self-cross-linking polymer comprises an acrylic emulsion.

6 The asphalt coating composition of embodiment 1, wherein the surfactant comprises a tetramethyldecynediol in ethylene glycol.

7 The asphalt coating composition of embodiment 1, wherein the surfactant comprises a non-ionic nonylphenol Ethoxylate.

8. The asphalt coating composition of embodiment 1, further comprising a de-foaming agent.

9. The asphalt coating composition of embodiment 8, wherein the de-foaming agent comprises polysiloxanes in polyglycol.

10. The asphalt coating composition of embodiment 1, further comprising a tinting agent.

11. The asphalt coating composition of embodiment 10, wherein the tinting agent comprises carbon black.

12. The asphalt coating composition of embodiment 1, further comprising less than 1% particulate content when passed through a 250 micron sieve.

13. The asphalt coating composition of embodiment 1, having a pH of between pH 4.0 and pH 6.0.

14. The asphalt coating composition of embodiment 1, free of aromatic organic solvents.

15. The method of treating asphalt pavement, which comprises applying the composition of embodiment 1 to the surface of the pavement.

16. The method of embodiment 15, wherein the rejuvenator comprises a tall oil derivative.

17. The method of embodiment 15, wherein the composition is applied at a rate of between 0.01 and 0.07 gallons per square yard.

18. The method of embodiment 15, which comprises spraying the composition onto the surface of an asphalt road.

19. The method of embodiment 15, wherein the composition is bio based.

20. The method of embodiment 15, which comprises applying the composition with an asphalt sealer spray machine.

Various modifications of the invention, in addition to those described herein, will be apparent to those skilled in the art from the foregoing description. Such modifications are also intended to fall within the scope of the appended claims. Each reference, including all patent, patent applications, and publications, cited in the present application is incorporated herein by reference in its entirety.

1. An asphalt rejuvenation composition comprising a rejuvenating agent, a self-cross-linking polymer, water and a surfactant.

2. The asphalt rejuvenation composition of claim 1, wherein the rejuvenating agent is a tall oil fatty acid derivative.

3. The asphalt rejuvenation composition of claim 2, wherein the rejuvenating agent is a tall oil-derived fatty ester.

4. The asphalt rejuvenation composition of claim 2 or 3, wherein the rejuvenating agent has a cyclic content of at least 5 wt. %.

5. The asphalt rejuvenation composition of any one of claims 1-4, wherein the rejuvenating agent is free of volatile organic compounds.

6. The asphalt rejuvenation composition of any one of claims 1-5, wherein the rejuvenating agent is present in an amount of about 15% to about 45% by weight of the asphalt rejuvenation composition.

7. The asphalt rejuvenation composition of any one of claims 1-6, wherein the self-cross-linking polymer is in an acrylic polymer emulsion.

8. The asphalt rejuvenation composition of claim 7, wherein the self-cross-linking polymer is in an acrylic polymer emulsion comprising the self-cross-linking polymer, an emulsion surfactant and water, wherein the self-cross-linking polymer comprises a combination of methylmethacrylate monomer and butyl acrylate monomer, and wherein the emulsion surfactant comprises alkyl ethyloxylates.

9. The asphalt rejuvenation composition of any one of claims 1-8, wherein the self-cross-linking polymer is present in an amount of about 5% to about 45% by weight of the asphalt rejuvenation composition, based on the weight solids of the acrylic polymer emulsion comprising the self-cross-linking polymer.

10. The asphalt rejuvenation composition of any one of claims 1-9, wherein the surfactant comprises a first surfactant and a second surfactant.

11. The asphalt rejuvenation composition of claim 10, wherein the first surfactant comprises a non-ionic nonylphenol ethoxylate.

12. The asphalt rejuvenation composition of claim 10 or 11, wherein the second surfactant comprises a tetramethyldecynediol in ethylene glycol.

13. The asphalt rejuvenation composition of any one of claims 10-12, wherein the first surfactant is present in an amount of about 2% to about 10% by weight of the asphalt rejuvenation composition.

14. The asphalt rejuvenation composition of any one of claims 10-13, wherein the second surfactant is present in an amount of about 0.05% to about 2.5% by weight of the asphalt rejuvenation composition.

15. The asphalt rejuvenation composition of any one of claims 1-14, further comprising a de-foaming agent.

16. The asphalt rejuvenation composition of claim 15, wherein the de-foaming agent comprises polysiloxanes in polyglycol.

17. The asphalt rejuvenation composition of claim 15 or 16, wherein the de-foaming is present in an amount of about 0.1% to about 1% by weight of the asphalt rejuvenation composition.

18. The asphalt rejuvenation composition of any one of claims 1-17, further comprising a tinting agent.

19. The asphalt rejuvenation composition of claim 18, wherein the tinting agent comprises carbon black.

20. The asphalt rejuvenation composition of any one of claims 1-19, further comprising less than 1% particulate content when passed through a 250 micron sieve.

21. The asphalt rejuvenation composition of any one of claims 1-20, having a pH of between pH 4.0 and pH 6.0.

22. The asphalt rejuvenation composition of any one of claims 1-21, free of volatile organic compounds.

23. The asphalt rejuvenation composition of any one of claims 1-22, wherein the asphalt rejuvenation composition comprises:
about 45% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition; and
about 0.01% to about 1% of acetic acid by weight of the asphalt rejuvenation composition.

24. The asphalt rejuvenation composition of any one of claims 1-22, wherein the asphalt rejuvenation composition comprises:
about 35% to about 75% of water by weight of the asphalt rejuvenation composition;
about 15% to about 45% of a rejuvenating agent by weight of the asphalt rejuvenation composition;
about 5% to about 45% of a self-linking-cross polymer by weight of the asphalt rejuvenation composition;
about 2% to about 10% of a first surfactant by weight of the asphalt rejuvenation composition;
about 0.05% to about 2.5% of a second surfactant by weight of the asphalt rejuvenation composition;
about 0.05% to about 2.5% of a de-foaming agent by weight of the asphalt rejuvenation composition;
about 0.01% to about 1% of acetic acid by weight of the asphalt rejuvenation composition; and
about 1% to about 20% of a tinting agent by weight of the asphalt rejuvenation composition.

25. The asphalt rejuvenation composition of claim 23 or 24, wherein:
the rejuvenating agent is a tall oil-derived fatty ester;
the self-linking-cross polymer is in an acrylic polymer emulsion comprising the self-linking-cross polymer, an emulsion surfactant, and water, wherein the self-linking-cross polymer comprises a combination of methylmethacrylate monomer and butyl acrylate monomer;
the first surfactant is a non-ionic nonylphenol ethoxylate;
the second surfactant is a tetramethyldecynediol in ethylene glycol;
the de-foaming agent is a mixture of hydrophobic solids and foam destroying polysiloxanes in polyglycol.

26. A method of treating asphalt pavement, which comprises applying the asphalt rejuvenation composition of any one of claims 1-25 to the surface of the asphalt pavement.

27. The method of claim 26, wherein the asphalt rejuvenation composition is applied at a rate of between 0.01 and 0.07 gallons per square yard.

28. The method of claim 26 or 27, which comprises spraying the composition onto the surface of the asphalt pavement, wherein the asphalt pavement is an asphalt road.

29. The method of any one of claims 26-28, which comprises spraying the asphalt rejuvenation composition of any one of claims 1-25 to the surface of the asphalt pavement; and wherein the asphalt pavement is dense-graded friction course pavement.

30. The method of any one of claims 26-28, which comprises applying the asphalt rejuvenation composition of any one of claims 1-25 to the surface of the asphalt pavement; and wherein the asphalt pavement is open-graded friction course pavement.

31. The method of any one of claims 26-30, which comprises applying the asphalt rejuvenation composition with an asphalt sealer spray machine.

32. The method of any one of claims 26-31, wherein the asphalt rejuvenation composition is applied as a single layer to the asphalt pavement.

33. The method of any one of claims 26-32, wherein the asphalt rejuvenation composition dries in about one hour to about two hours on the asphalt pavement without the need for sanding.

34. The method of any one of claims 26-33, wherein the complex modulus and the complex viscosity of the asphalt pavement are reduced by at least 40% at three months post-treatment with the asphalt rejuvenation composition.

35. The method of treating asphalt pavement, which comprises mixing the asphalt rejuvenation composition of any one of claims 1-25 with RAP and applying the admixture to the surface of the asphalt pavement.

36. The method of claim 35, wherein the asphalt rejuvenation composition comprises a Tall Oil Derivative.

37. The method of claim 36, wherein the asphalt rejuvenation composition comprises a self-cross linking polymer.
